(19) United States
(12) Patent Application Publication
(10) Pub. No.: US 2014/0161485 A1
(43) Pub. Date: Jun. 12, 2014

(54) DEVELOPING DEVICE, PROCESS CARTRIDGE INCLUDING DEVELOPING DEVICE, AND IMAGE FORMING DEVICE INCLUDING DEVELOPING DEVICE

(71) Applicant: Samsung Electronics Co., Ltd., Suwon-si (KR)

(72) Inventors: Manabu Ono, Yokohama-si (JP); Satoshi Muramatsu, Yokohama-si (JP)

(73) Assignee: Samsung Electronics Co., Ltd., Suwon-si (KR)

(21) Appl. No.: 14/101,474

(22) Filed: Dec. 10, 2013

(30) Foreign Application Priority Data
Dec. 10, 2012 (JP) 2012-269319
Dec. 28, 2012 (JP) 2012-287545
Oct. 29, 2013 (KR) 10-2013-0129571

(51) Int. Cl. G03G 15/08; G03G 21/18

(52) U.S. Cl. CPC G03G 15/0812; G03G 21/18
USPC 399/111; 399/284

(57) ABSTRACT

A developing device is provided capable of properly maintaining charging characteristics of developer and configured to be easily assembled.

### CROSS-REFERENCE TO RELATED APPLICATIONS

This application is related to, and claims priority to, Japanese Patent Application No. 2012-0269319, filed on Dec. 10, 2012, in the Japanese Patent Office, Japanese Patent Application No. 2012-0287545, filed on Dec. 28, 2012, in the Japanese Patent Office, and Korean Patent Application No. 10-2013-0129571, filed on Oct. 29, 2013, in the Korean Intellectual Property Office, the disclosures of which are incorporated herein in by reference.

### BACKGROUND

1. Field

One or more embodiments relate to a developing device, a process cartridge, and an image forming apparatus that are used to electrophotographically form images, and more particularly to a developing device including a developer carrier on which convex and concave portions are regularly arranged, a process cartridge, and an image forming apparatus.

2. Description of the Related Art

Examples of image forming apparatuses configured to form images on recording materials (recording media) by electrophotography include copy machines, printers, fax machines, word processors, and multi-function devices (multi-function printers) having functions thereof. A developing device may be used to develop an electrostatic latent image formed on an image carrier such as an electrophotographic photoconductor into a visible image by using developer. A process cartridge includes an electrophotographic photoconductor and a developer functioning as a processor acting on the electrophotographic photoconductor, and the electrophotographic photoconductor and the developing part are packaged in the process cartridge. The process cartridges may be detachably attached to an image forming apparatus.

In an electrophotographic image forming apparatus, the surface of an electrophotographic photoconductor such as a photoconductor drum may be uniformly charged and selectively exposed to light to form an electrostatic latent image thereon. The electrostatic latent image may be developed into a toner image by using developer such as toner carried on a developer carrier such as a developing roller. The toner image may be transferred from the photoconductor drum to a recording material, and heat or pressure may be applied to the toner image to fuse the toner image onto the recording material.

In such an image forming apparatus, it may be necessary to improve a method of charging toner so as to stably form precise images. For example, a developing device including a developer carrying roller on which convex and concave portions are regularly arranged has been proposed to charge toner by a rolling motion without stains.

In the developing device, a developer regulating member may be used to regulate the thickness of a toner layer carried on the developer carrying roller. Toner carried on the surface of the developer carrying roller may be pressed by a flat surface of the developer regulating member and may be rotatably moved while making contact with the surface of the developer carrying roller or the developer regulating member, so as to be properly charged.

However, according to the results of a detailed study conducted by the inventors of the present invention, the layer thickness of toner regulated (hereinafter referred to as a regulation amount of developer) on the developer carrying roller on which convex and concave portions are arranged may be largely varied even though contact conditions between the developer regulating member and the developer carrying roller were slightly changed.

For example, FIG. 1 illustrates an amount of developer regulated on the developer carrier with respect to the protruding amount of the developer regulating member.

The protruding amount of the developer regulating member (hereinafter referred to as a protruding amount) may be one of contact conditions of the developer regulating member and may be defined as a distance moved by a leading end of the developer regulating member from a state of making contact with the developer carrier to a state of being separated from the developer carrier.

The regulation amount of developer may be increased as the protruding amount is increased, and bending points 40 and 50 may be present in the slope of the regulation amount due to the influence of the surface shape of the developer carrier.

When the protruding amount is small (refer to region 10 in FIG. 1), since most of the developer is filled in the concave portions (refer to FIG. 2A), charging characteristics may be satisfactory but a sufficient amount of developer is not carried. If the protruding amount is increased, filing of developer into the concave portions may be completed at the bending point 40. After the bending point 40 (that is, in region 20 in FIG. 1), filling of developer into the concave portions proceeds, and some of the developer overflows to the top surfaces of the convex portions (refer to FIG. 2B). After the bending point 50 (that is, in region 30 in FIG. 1), developer not filled in the concave portions forms a single layer or thicker layer of the developer (refer to FIG. 2C), which has a negative effect on charging characteristics of the developer.

That is, in a region before the bending point 40 (region 10 in FIG. 1), it may difficult to ensure a sufficient amount of developer for forming images, and in a region after the bending point 50 (region 30 in FIG. 1), characteristics of the developer carrying roller may be deteriorated and various errors such as image forming errors are caused.

Therefore, to maintain the properties of the developer carrier including the convex and concave portions thereon, it may be necessary that the protruding amount of the developer regulating member may be adjusted between the bending points 40 and 50 (within region 20 in FIG. 1) and be maintained at the adjusted state.

However, in the region between the bending points 40 and 50, the variation rate of the regulation amount of developer with reference to the protruding amount (corresponding to the slope of lines in FIG. 1) is large, and thus the dimensional tolerance (a range between upper and lower limits) of the protruding amount (center value) is small with respect to an allowable variation (a range between upper and lower limit values) of a desired regulation amount (set amount) of developer. Thus, it may be difficult to adjust the protruding amount or perform an assembling process.

Although the regulation amount of developer of the developing device may be adjusted, the regulation amount of developer may be easily varied due to abrasion of the developer regulating member or the developer carrier, which may make it difficult to control image density or color balance. That is, the developing device may not be suitable for being used in an image forming apparatus which is repeatedly operated to form images.

Furthermore, in the case in which the developing device is installed in a process cartridge forming images infrequently, it may be difficult to act on a torsion or a distortion of the developing device caused by an external driving device used to drive the developing device, which may cause image density unevenness or color stains on the same page. Thus, the developing device needs improvements to be put to practical use.

As a developing technique, using toner is well-known. A developing device may include a developing roller having a shape of a cylinder or circular pillar, convex and concave portions being formed, to carry toner, on an outer surface of the developing roller. The developing roller may include a plurality of concave portions extending in a direction angled 45° from the rotation direction of the developing roller, and a plurality of concave portions extending in a direction angled 45° oppositely from the rotation direction of the developing roller. The plurality of concave portions may be arranged to cross each other, and thus a plurality of convex portions which have diamond shape may be formed as illustrated in FIG. 20.

However, the sectional area of the convex and concave portions of the developing roller may be varied according to the rotation positions. As illustrated in FIG. 20, a concave portion may have different widths in section A-A and section B-B. If the widths of the concave portions are different from each other, the amount of developer filled in the developed roller may be varied according to the rotation positions of the developing roller. Images having uneven density may be formed, to lower the quality of the images.

In the developing roller, toner stagnates at intersections between the concave portions extending in a direction angled 45° from the rotation direction and the concave portions extending in a direction angled 45° oppositely from the rotation direction. As illustrated in FIG. 20, toner may be likely to stagnate at apexes (X) of the convex portions, and in this case, stagnation of toner may expand from the apexes (X) to cause charging errors. Due to stagnation of toner, the surface of the developing roller may be contaminated or toner may be scattered.

Toner stagnating on the surface of the developing roller may stick thereto, to cause toner carrying errors. As a result, stripes may present in images, or image density may be varied. Toner stagnating on the surface of the developing roller and not used for developing may not be easily collected by a toner collecting part, which may cause charging errors when new toner is supplied.

### SUMMARY

One or more embodiments include a developing device, a process cartridge, and an image forming apparatus, the developing device having a structure, in which the state of developer carried on a developer carrying roller having convex and concave portions is controlled to maintain charging characteristics of the developer, and a developer regulating member is configured to be easily installed and adjusted for easily performing an assembling process in a mass production line.

One or more embodiments include a developing device, a process cartridge, and an image forming apparatus that are configured such that although image forming may be repeatedly performed, image density or color balance is little varied by abrasion of a developer regulating member or a developer carrier.

One or more embodiments include a developing device, a process cartridge, and an image forming apparatus that are configured to minimize variations of image density or color balance caused by externally-caused stress.

One or more embodiments include a developing device, a process cartridge, and an image forming apparatus that are configured to prevent toner stagnation on a developing roller and improve image quality.

Additional aspects will be set forth in part in the description that follows and, in part, will be apparent from the description, or may be learned by practice of the disclosed embodiments.

According to an exemplary embodiment, a developing device includes, a developer containing chamber configured to contain developer, a developing chamber adjacent to the developer containing chamber, a barrier wall separating the developer containing chamber and the developing chamber, the barrier wall including an opening to connect the developer containing chamber and the developing chamber, a developer carrier rotatably disposed to carry the developer filled in the developing chamber, a developer supply member disposed in the developing chamber and configured to supply the developer, supplied through the opening, to the developer carrier, and a developer regulating member making contact with a circumferential surface of the developer carrier, the developer regulating member being configured to regulate a layer thickness of the developer supplied to a surface of the developer carrier. The developer supply member is rotatable while facing and making contact with the developer carrier, the developer supply member and the developer carrier move in opposite directions in a contact region therebetween. The developer carrier includes a developer carrying surface, and the developer carrying surface include a plurality of convex portions configured to contain the developer and concave portions respectively surrounding the convex portions. A height difference between top surfaces of the convex portions and bottom surfaces of the concave portions is equal to or greater than 0.8 times a weight average particle diameter D4 of the developer but less than 5.0 times the weight average particle diameter D4 of the developer. If an imaginary surface obtained by extending the top surfaces of the convex portions of the developer carrying surface in axial and circumferential directions is defined as an entire circumferential surface, a ratio of a total area of the top surfaces of the convex portions to an area of the entire circumferential surface is equal to or greater than 3% but less than 40%. A contact position between the developer carrier and the developer regulating member is lower than a contact position between the developer carrier and the developer supply member. An excessive developer regulated by the developer regulating member from the developer carrier and is stored in a developer collecting part disposed at a lower position in the developing chamber.

According to an exemplary embodiment, an excessive developer on the developer carrier regulated by the developer regulating member may not be directly collected in the developer containing chamber but may be collected in the developer collecting part disposed at a lower position in the developing chamber. Since the excessive developer collected in the developer collecting part is already properly charged, the excessive developer may be gradually compressed in a space defined from the barrier wall forming the developer collecting part to a contact position between the developer carrier and a developer supply part, and may be easily moved to the concave portions of the developer carrier while maintaining a gradually compressed state owing to an electrostatic repulsive force therebetween.

The contact position between the developer carrier and the developer regulating member may be disposed to be lower than the contact position between the developer carrier and the developer supply part. For example, the contact position between the developer carrier and the developer regulating member may be between the barrier wall forming the developer collecting part and the contact position between the developer carrier and the developer supply part. By disposing the contact position between the developer carrier and the developer regulating member as above, it is possible to circulate toner through the contact positions by uniform and gradual pressure, allow toner to stably penetrate into the concave portions of the developer carrier, and increase the degrees of freedom of contact conditions (protruding amount) between the developer carrier and the developer regulating member.

According to an exemplary embodiment, a developing device includes: a developing roller including convex and concave portions on a surface thereof for attaching toner to the convex and concave portions, a toner supply part supplying toner to the developing roller, and a developer regulating member making contact with a surface of the developing roller to regulate an amount of toner attached to the developing roller. The concave portion of the developing roller includes a first concave portion extending in a direction inclined with respect to a rotation direction of the developing roller, a second concave portion extending in a direction different from the rotation direction or the direction in which the first concave portion extends, and a third concave portion continuing from the first and second concave portions and extending in the rotation direction.

In the developing device, the third concave portion continues from the first and second concave portions and extends in the rotation direction. Owing to the third concave portion extending in the rotation direction, the width of the concave portion may be less varied along the rotation positions of the developing roller, and thus the filling amount of tonner and image density may be less deviated. Since the third concave portion extends in the rotation direction, toner may easily move in the rotation direction, and thus stagnation of toner may be reduced. Therefore, errors may not be caused by toner stagnation, and thus image quality may be improved.

The first to third concave portions may satisfy the following inequality: 0.7≦c/(a+b)≦1.4 where “a” denotes the width of the first concave portion in the rotation direction, “b” denotes the width of the second concave portion in the rotation direction, and “c” denotes the width of the third concave portion in the rotation direction. In this case, since the sum of the widths of the first and second concave portions is similar to the width of the third concave portion, the filling amount of toner may be uniform along the rotation positions of the developing roller. In addition, if a, b, and c satisfy 0.9≦c/(a+b)≦1.2, since the sum of the widths of the first and second concave portions is much similar to the width of the third concave portion, the amount of toner filled therein may be more uniform, and thus image quality may be improved.

The sum of the widths of the first and second concave portions measured in a section taken in the rotation direction of the developing roller may be approximately equal to the width of the third concave portion measured in the section. In this case, since the amount of toner filled in the concave portion is not varied along the rotation positions of the developing roller, image density may not be deviated, and image quality may be further improved.

The developing device may satisfy the following inequality d<h<3d where “h” denotes the depth of the concave portion of the developing roller, and “d” denotes the average particle diameter of toner. Since the number of toner particles filled in the depth direction of the concave portion is fewer than three and the depth of the concave portion is not large, sticking and filming of toner may be prevented, and thus the lifespan of the developing device may be increased.

The developing device may include a photoconductor drum receiving toner from the developing roller, and the rotation speed of the developing roller may be approximately 1.0 to 3.0 times the rotation speed of the photoconductor drum. Sticking and filming of toner may be prevented, and thus the lifespan of the developing device may be increased.

According to a developing device, a process cartridge, and an image forming apparatus of exemplary embodiments, charging of developer may be properly performed/maintained for forming satisfactory images, and easy assembling and high mass productivity may be provided. Although image forming may be repeatedly performed, a variation of image density or color balance by abrasion of the developer regulating member or the developer carrier may be prevented and minimized. A variation of image density or color balance by externally-caused stress may be prevented and minimized.

According to a developing device, a process cartridge, and an image forming apparatus of an exemplary embodiment, toner stagnation on the developing roller may be prevented, and image quality may be improved.

### BRIEF DESCRIPTION OF THE DRAWINGS

These and/or other aspects will become apparent and more readily appreciated from the following description of the embodiments, taken in conjunction with the accompanying drawings in which:

FIG. 1 is a view illustrating a relationship between an amount of developer regulated on a developer carrier and the protruding amount of a developer regulating member in a developing device, the developer carrier having a surface on which convex and concave portions are regularly arranged;

FIGS. 2A to 2C illustrate regulated states of developer (toner) on the developer carrier having a surface on which convex and concave portions are regularly arranged;

FIG. 3 illustrates a protruding amount of a developer regulating member;

FIG. 4 illustrates a one-component developing unit;

FIGS. 5A to 5C illustrate a developer carrier according to an embodiment;

FIGS. 6A-6C illustrate top surfaces of convex portions arranged on a developer carrier;

FIGS. 7A-7C illustrate top surfaces of convex portions arranged on a developer carrier for the case in which the convex portions have different shapes;

FIGS. 8A and 8B illustrate exemplary one-component developing units;

FIG. 9 illustrates an exemplary a one-component developing unit;

FIG. 10 illustrates an exemplary one-component developing unit;

FIG. 11 illustrates an exemplary relationship between a regulation amount of developer on a developer carrier and the protruding amount of a developer regulating member;

FIG. 12 illustrates an exemplary relationship between a regulation amount of developer on a developer carrier and the protruding amount of a developer regulating member;

FIG. 13 illustrates a developing device according to an embodiment;

FIG. 14 illustrates an exemplary developing roller of a developing device;

FIG. 15 illustrates an exemplary portion of a surface of the developing roller;

FIG. 16 illustrates an exemplary relationship between the amount of toner on the developing roller and the number of printed pages;

FIG. 17 is a graph illustrating an exemplary relationship between a toner sticking occurring time and the widths of first to third concave portions;

FIG. 18 is a graph illustrating an exemplary relationship between the flow density of toner and the depth of concave portions;

FIG. 19 is a graph illustrating an exemplary relationship between the time at which toner is firmly fixed and the widths of first to third concave portions; and

FIG. 20 is an enlarged view illustrating the surface of a developing roller.

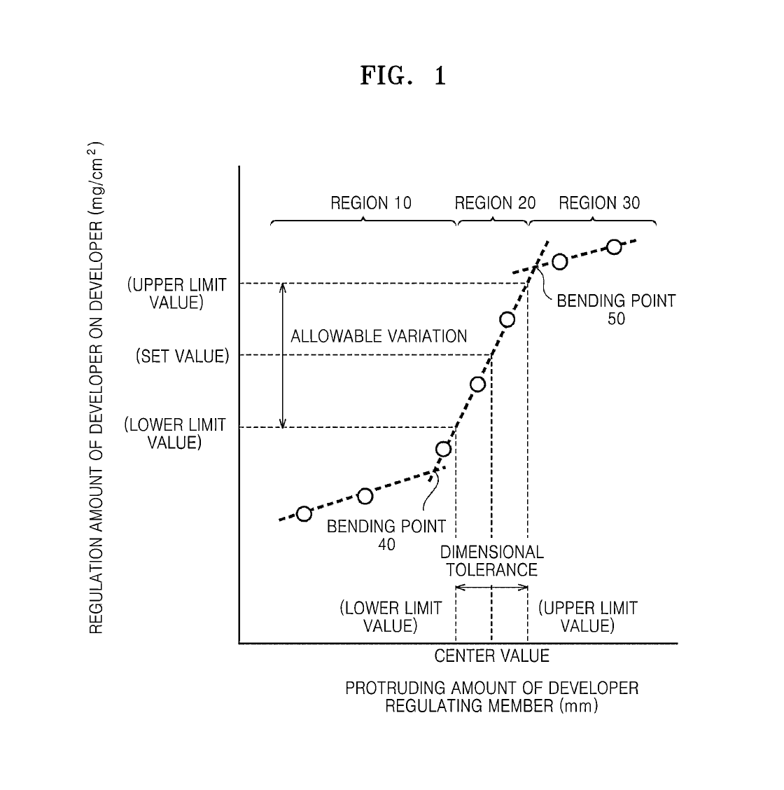

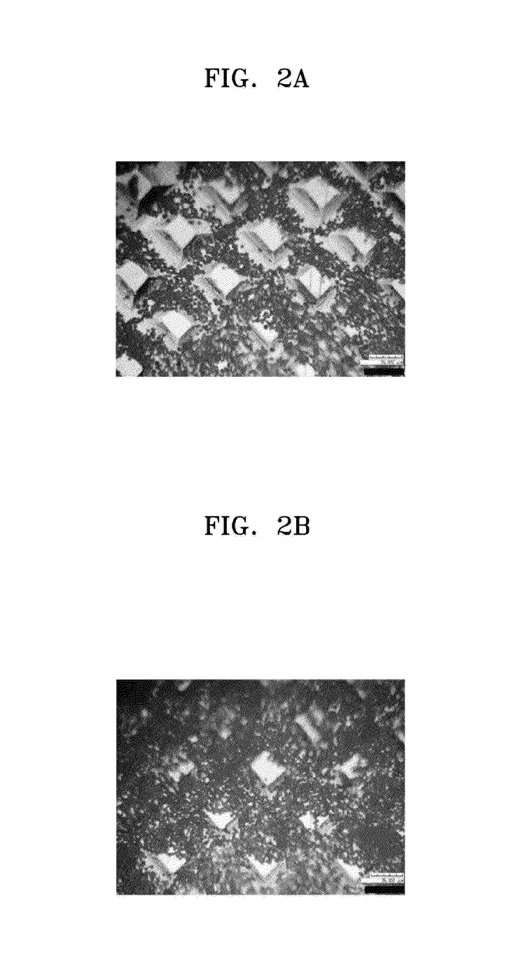

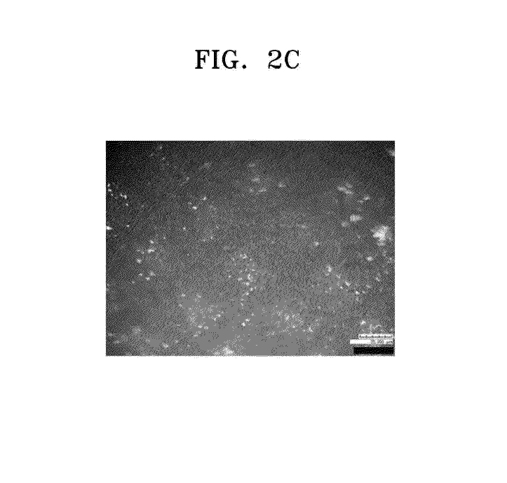

### DETAILED DESCRIPTION

Reference will now be made in detail to embodiments, examples of which are illustrated in the accompanying drawings, wherein like reference numerals refer to like elements throughout. In this regard, dimensions, materials, shapes, and relative positions of elements of a device may vary according to the structure or conditions of the device, and the embodiments may have different forms and should not be construed as being limited to the descriptions set forth herein. Accordingly, the embodiments are described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Exemplary embodiments relate to an image forming apparatus, such as copy machines, printers, fax machines, word processors, and multi-function devices (multi-function printers), which form images on recording materials (recording media) by electrophotography.

An image forming apparatus and an image forming method using apparatus are disclosed.

<Image Forming Apparatus and Image Forming Method>

An exemplary image forming method includes charging an electrostatic latent image carrier by applying a voltage to a charging member from an external power source, forming an electrostatic latent image on the charged electrostatic latent image carrier, developing the electrostatic latent image formed on the electrostatic latent image carrier into a toner image by using developer (toner), transferring the toner image from the electrostatic latent image carrier to a transfer material, and firmly fixing the toner image to the transfer material with heat. An image forming method may include a cleaning process to remove residual substances such as toner from the surface of the electrostatic latent image carrier.

An exemplary image forming apparatus using a one-component developing method is disclosed.

In the image forming apparatus, a charging part capable of charging a surface of the electrophotographic photoconductor, an exposing part that is a latent image forming capable of exposing the charged electrophotographic photoconductor to light and forming an electrostatic latent image thereon according to image information, a developing part that is a developing capable of developing the electrostatic latent image into a toner image by using toner, a transfer part capable of transferring the toner image from the electrophotographic photoconductor to a surface of a transfer target medium, and a cleaning part capable of removing toner remaining on the electrophotographic photoconductor after the toner image is transferred are sequentially arranged around an electrophotographic photoconductor.

A fusing part capable of firmly fixing the toner image to the transfer target medium is disposed on a proceeding passage of the transfer target medium on the transfer part.

Operation of an image forming apparatus is disclosed.

The charging part uniformly charges the electrophotographic photoconductor (a charging process). The exposing part emits light to the surface of the electrophotographic photoconductor, and charges on portions exposed to the light are removed from the electrophotographic photoconductor, thereby forming an electrostatic image (electrostatic latent image) on the electrophotographic photoconductor (electrostatic latent image forming process). The developing part develops the electrostatic image of the electrophotographic photoconductor into a toner image (developing process).

For example, the image forming apparatus may be a digital electrophotographic copy machine including an organic photoconductor as the electrophotographic photoconductor and a laser beam exposing part as the exposing part. The surface of the electrophotographic photoconductor is charged with a negative potential by the charging part, and a digital dot latent image is formed on the electrophotographic photoconductor by a laser beam. The developing part develops the digital dot latent image into a toner image by applying toner to portions exposed to the laser beam.

The transfer part places a transfer target medium such as paper on the toner image and applies a charge having a polarity opposite to that of the toner image to the back side of the transfer target medium so as to transfer the toner image to the transfer target medium by an electrostatic force (transferring process). The fusing part applies heat and pressure to the toner image of the transfer target medium through a fusing member so as to fuse and firmly fix the toner image onto the transfer target medium (fusing process).

Toner remaining on the electrophotographic photoconductor after the transferring process is removed by the cleaning part (cleaning process). The serial processes from the charging process to the cleaning process constitute a single cycle.

A toner image may be transferred to a transfer target medium through an intermediate transfer part.

One or more parts and methods that are capable of charging, an carrying an electrostatic latent image carrier, exposing, developing, transfer, cleaning, and fusing, for example, in an image forming apparatus are disclosed.

[Charging]

For example, a charger using corona discharge, or a conductive or semiconductive charging roll may be used as the charging part. A contact type charger using a conductive or semiconductive charging roll may apply a DC current or AC current to the electrophotographic photoconductor. The charging part generates an electric discharge in a small space adjacent to the electrophotographic photoconductor so as to charge the surface of the electrophotographic photoconductor. The conductive or semiconductive charging roll may have a single-layer or multilayer structure. A cleaning mechanism may be further used to clean the surface of the charging roll.

[Electrostatic Latent Image Carrier]

The electrostatic latent image carrier has a latent image (electrostatic image) forming function. The electrophotographic photoconductor may be used as the electrostatic latent image carrier. The electrophotographic photoconductor includes a cylindrical base, and a coating film including an organic photoconductor and formed on the outer surface of the cylindrical base. The coating film may be formed by sequentially coating the cylindrical base with an under coating layer, a charge generation layer containing a charge generation material, and a photoconductor layer including a charge transport layer containing a charge transport material. The charge generation layer and the charge transport layer may be formed in the opposite order. In a stack type photoconductor, a charge generation material and a charge transport material are included in different layers (a charge generation layer and a charge transport layer) and are stacked, and in a single-layer photoconductor, a charge generation material and a charge transport material are included in the same layer. The electrophotographic photoconductor may be a stack type photoconductor. An intermediate layer may be disposed between the under coating layer and the photoconductor layer. Another photoconductor layer such as an amorphous silicon photoconductor film may be used instead of the organic photoconductor.

[Exposing]

The exposing part is not limited to a particular type. For example, the exposing part may be an optical unit capable of emitting semiconductor laser light, diode (LED) light, or liquid crystal shutter light to the electrostatic latent image carrier according to an image to be formed.

[Developing]

The developing part includes a developer carrier, developer (toner), and a developer regulating member. The developing part may include a developer supply member or an agitating carrying member to supply developer to the developer carrier. The developer carrier may be configured to supply developer to an electrostatic latent image formed on the outer surface of the electrophotographic photoconductor. For example, the developer carrier is a circular or cylindrical member formed of a nonmagnetic metal or a polymer material. The developer carrier may be rotatable while facing the electrophotographic photoconductor. The developer carrier includes a developing-bias applying part to apply a developing bias voltage.

The developer regulating member may be disposed at an upstream side in a rotation direction of the developer carrier based on a position at which the developer carrier and the electrophotographic photoconductor face each other. The developer regulating member is used to equalize the thickness of developer along the circumferential surface of the developer carrier. For example, the developer regulating member may include a metal blade.

If nonmagnetic one-component toner is used as developer, the agitating carrying member carries and supplies developer to the surface of the developer carrier directly and/or through the developer supply member. A predetermined developing bias voltage is applied between the developer carrier and the electrophotographic photoconductor, and developer is transferred from the developer carrier to the electrophotographic photoconductor according to an electrostatic latent image so as to form a toner image (visible image).

[Transfer]

The transfer part applies a charge having a polarity opposite to that of toner to the back side of a transfer target medium for transferring a toner image to the transfer target medium by an electrostatic force, or makes directly contact with a surface of a transfer target medium for transferring the toner image to the transfer target medium. For this, the transfer part may include a transfer roll such as a conductive or semiconductive roll, and a transfer roll pressing device. A DC current may be applied to the transfer roll or an AC current may be applied to the transfer roll in an overlapped manner, as a transfer current to be applied to the electrostatic latent image carrier. The transfer roll may be configured according to the width of an image region to be transferred, the shape of a transfer charger, the width of an opening, and a process speed. A single-layer foam roll may be used as the transfer roll for reducing costs. A toner image may be transferred to a transfer target medium such as paper directly or through an intermediate transfer part.

An intermediate transfer part may be used. The intermediate transfer part may be formed of a material such as polycarbonate (PC), polyvinylidene fluoride (PVDF), polyalkylene terephthalate, a blend of PC/polyalkylene terephthalate (PAT), ethylene tetrafloro ethylene (ETFE)/PC, ETFE/PAT, or a blend of PC/PAT. For example, in view of mechanical strength, an intermediate transfer belt formed of a thermosetting polyimide resin may be used as the intermediate transfer part.

[Cleaning]

The cleaning part may be any type such as a blade cleaning type, a brush cleaning type, or a roll cleaning type as long as the cleaning part is capable of cleaning toner remaining on the electrostatic latent image carrier. For example, an elastic cleaning blade may be used as the cleaning part.

[Fusing]

The fusing part (image fusing device) may be used to firmly fix a toner image to a transfer target medium by heating, pressing, or heating and pressing the toner image. The fusing part includes a roller or belt type fusing member.

The above-described image forming apparatus forms an image on a recording material (such as a recording paper sheet or a plastic sheet) according to image information. Such image information is input to the image forming apparatus from an image reading device connected to the image forming apparatus or a host device such as a personal computer communicating with the image forming apparatus.

A developing device of the image forming apparatus is disclosed.

[Developing Device]

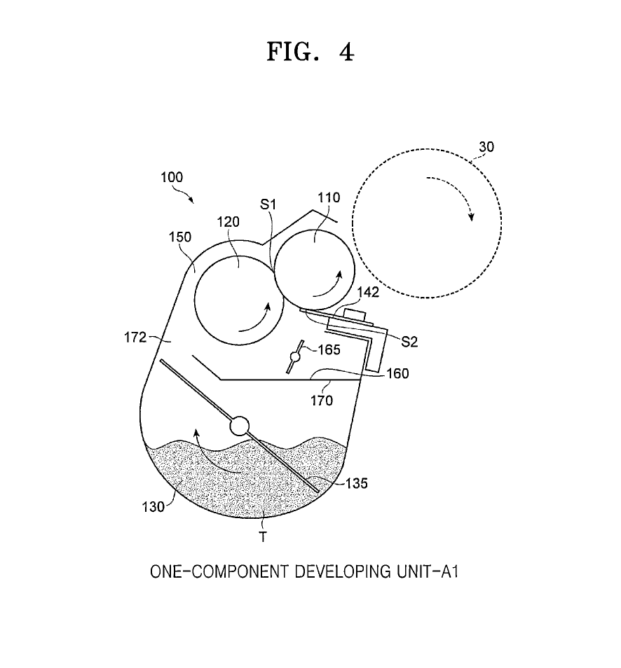

FIG. 4 is a cross-sectional view schematically illustrating a developing device 100 of the image forming apparatus according to an embodiment. For example, the image forming apparatus may include magenta, yellow, cyan, and black developing devices 100 to form color images using magenta, yellow, cyan, and black colors. In addition to including developing device 100 having a developing roller (toner carrier) 110, the image forming apparatus includes a recording medium carrying unit configured to feed paper, a transfer unit configured to secondarily transfer a toner image to paper, a photoconductor drum 30 being an electrostatic latent image carrier around which an image will be formed, and a fusing unit configured to attach a toner image to paper.

If an image signal of an image to be formed is input to the image forming apparatus, a controller of the image forming apparatus signals a charging roller to uniformly charge the surface of the photoconductor drum 30 with a predetermined potential based on the image signal. Thereafter, an exposing unit emits laser light to the surface of the photoconductor drum 30 to form an electrostatic latent image on the photoconductor drum 30. In the developing device 100, a toner supply roller (developer supply part) 120 supplies toner T (developer) from a developing chamber to the developing roller 110.

If the toner is carried to a region facing the photoconductor drum 30 as the developing roller 110 rotates, the toner starts to move from the developing roller 110 to the electrostatic latent image formed on the circumferential surface of the photoconductor drum 30, thereby developing the electrostatic latent image. Such developing may be performed for each of magenta, yellow, cyan, and black colors. A toner image formed in this manner is first transferred from the photoconductor drum 30 to a transfer belt in a region where the photoconductor drum 30 and the transfer belt face each other. The toner image is secondarily transferred to paper which is carried by the recording medium carrying unit. Thereafter, the paper on which the toner image is secondarily transferred is carried to the fusing unit for fixing the toner image to the paper, and then the paper is discharged to the outside of the image forming apparatus.

As illustrated in FIG. 4, the developing device 100 includes the toner supply roller 120, a toner containing chamber (developer containing chamber) 130, an elastic blade (developer regulating member) 140 having an elastic contact part 142, a developing chamber 150, a toner collecting part (developer collecting part) 160, a barrier wall 170, a carrying member 135, and an agitating member 165, as well as including the developing roller 110. Although the image forming apparatus includes magenta, yellow, cyan, and black developing devices 100, the magenta, yellow, cyan, and black developing devices 100 may the same basic structure except for the kind of toner (developer).

The toner containing chamber 130 is a chamber for containing toner T. The developing chamber 150 is a chamber for developing an image using the developing roller 110 and disposed to be adjacent to the upper side of the toner containing chamber 130. The barrier wall 170 may be disposed between the toner containing chamber 130 and the developing chamber 150 to separate the toner containing chamber 130 and the developing chamber 150. An opening 172 is formed in a portion of the barrier wall 170 to connect the toner containing chamber 130 and the developing chamber 150. The toner containing chamber 130, the developing chamber 150, and the barrier wall 170 are formed in one piece.

The carrying member 135 may be disposed in the toner containing chamber 130 to carry toner T to the developing chamber 150. The carrying member 135 is rotatable so that a predetermined amount of toner T may be carried from the toner containing chamber 130 to the developing chamber 150 through the opening 172 of the barrier wall 170 by rotation of the carrying member 135.

Toner T supplied from the toner containing chamber 130 by the carrying member 135 and toner T scraped down from the developing roller 110 by the elastic blade 140 may be agitated and mixed by the agitating member 165 and are supplied to the developing roller 110 by the toner supply roller 120. The toner supply roller 120 may be disposed in the developing chamber 150 to face and make contact with the circumferential surface of the developing roller 110. For example, the toner supply roller 120 is formed of an elastic member such as polyurethane foam so that the toner supply roller 120 may make contact with the developing roller 110 while being elastically deformed.

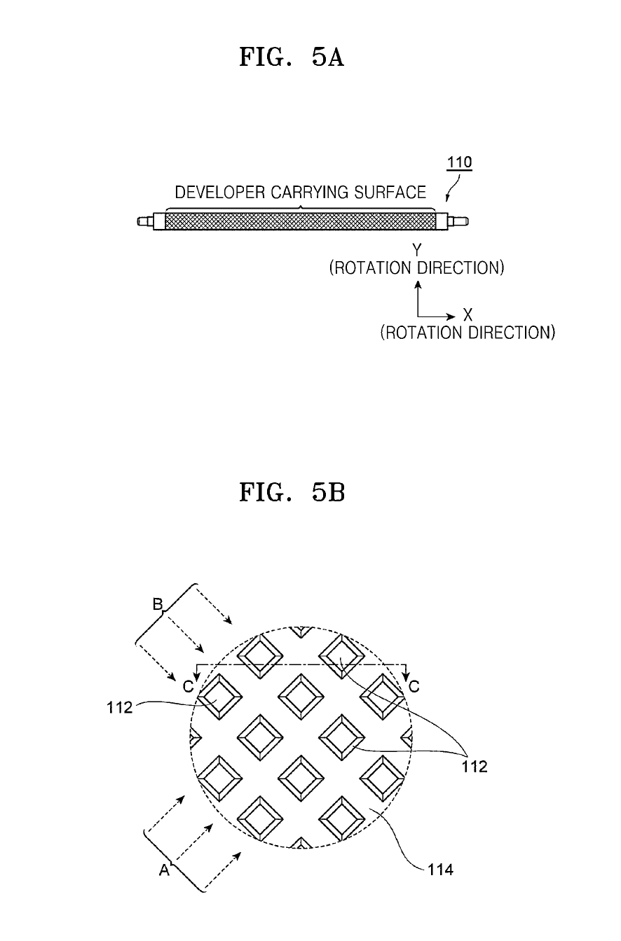

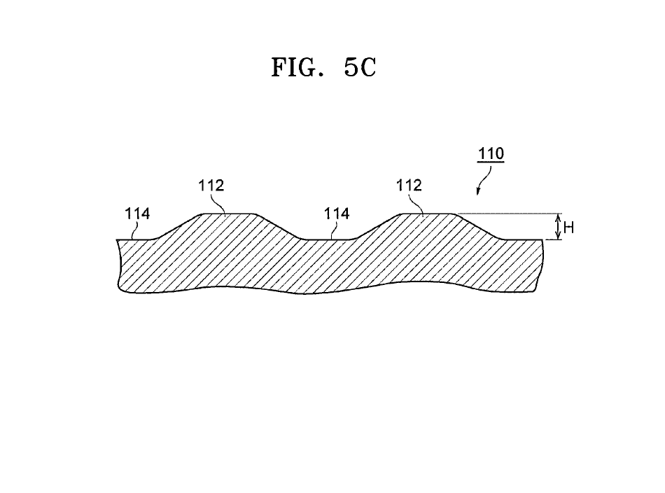

For example, the toner supply roller 120 and the developing roller 110 are rotated counterclockwise so that the toner supply roller 120 and the developing roller 110 may move in opposite directions in a contact region therebetween. The agitated and mixed Toner T attached to the toner supply roller 120 is supplied to and retained on the developing roller 110 as the toner supply roller 120 makes contact with the surface (refer to FIGS. 5A to 5C) of the developing roller 110. While the toner supply roller 120 supplies toner T to the developing roller 110, the toner supply roller 120 may also scrape toner T at the same time, not used in developing and passed a developing nip formed on the photoconductor drum 30, from the developing roller 110, thereby preventing an increase in charging amount caused by toner T remaining on the developing roller 110 for a long period of time.

The developing roller 110 carries toner T, supplied from the toner supply roller 120, to a region facing the photoconductor drum 30 and supplies the toner T to an electrostatic latent image formed on the circumferential surface of the photoconductor drum 30 to develop the electrostatic latent image. The developing roller 110 may be disposed in the developing chamber 150 to face and make contact with the circumferential surface of the toner supply roller 120 and face the photoconductor drum 30.

[Structure of Developer Carrier]

The developing roller 110 has a surface (hereinafter referred to as a developer carrying surface) including a plurality of convex portions 112 carrying developer and concave portions 114 surrounding the convex portions 112. For example, the developing roller 110 may be formed by treating a roller base made of a material such as an aluminum alloy or a steel alloy through a known surface treatment process such as form rolling or etching. The developing roller 110 may be treated through an addition process such as a polishing or plating process.

Referring to FIGS. 5A to 5C illustrating an exemplary embodiment, the convex portions 112 of the developer carrying surface of the developing device 100 may have a rhombic or square shape with diagonal lines thereof being parallel with a rotation axis (x-axis direction) of the developing roller 110. The convex portions 112 may have a trapezoidal shape in a cross-section is taken along line C-C.

On the developer carrying surface, the height difference between the top surfaces of the convex portions 112 and the bottom surfaces of the concave portions 114 may be equal to, or greater than, 0.8 times a weight average particle diameter D4 of developer, but less than 5.0 times the weight average particle diameter D4 of the developer. If an imaginary surface obtained by extending the top surfaces of the convex portions 112 of the developer carrying surface, which form portions of a cylindrical surface, in an axial direction (x-axis direction in FIG. 5A) and a circumferential direction (y-axis direction in FIG. 5A) is defined as an entire circumferential surface, the ratio of the total area of the top surfaces of the convex portions 112 to the area of the entire circumferential surface (hereinafter referred to as an area percentage of the top surfaces of the convex portions 112) may be equal to, or greater than, 3% but less than 40%.

According to an exemplary embodiment, the convex portion area percentage, and the height difference between the top surfaces of the convex portions 112 and the bottom surfaces of the concave portions 114 of the developing roller 110 are disclosed.

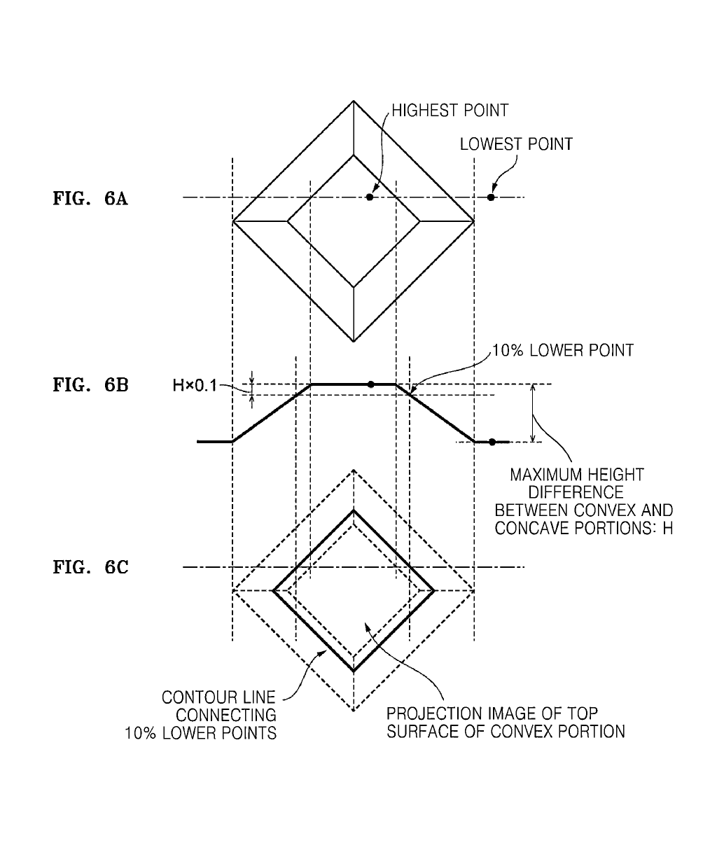

As illustrated in FIG. 6A, the top surface of one of the convex portions 112 and the bottom surface of one of the concave portions 114 surrounding the convex portion 112 may be measured to find the highest point of the top surface and the lowest point of the bottom surface, and the height difference between the highest point and the lowest point (hereinafter referred to as a maximum height difference) may be measured.

The same measurement may be performed on other convex portions 112 to measure the maximum height differences thereof and calculate the average of the maximum height differences. The average may be defined as the height difference between the top surfaces of the convex portions 112 and the bottom surfaces of the concave portions 114 (hereinafter referred to as a height difference H between the convex portions 112 and the concave portions 114).

The ratio of the total area of the top surfaces of the convex portions 112 to the area of the entire circumferential surface may be defined as follows.

Referring to FIG. 6B, a point lower than the highest point of the convex portion 112 by 10% of the height difference H may be determined (as a 10% lower point). A surface of the convex portion 112 containing a contour line connecting the 10% lower points than the highest point may be assumed as a top surface of the convex portion 112. The area of a projection image obtained by vertically projecting the top surface of the convex portion 112 on a plane may be measured (refer to FIG. 6C).

A similar measurement may be performed on other convex portions 112, and the average thereof may be defined as an area of each of the top surfaces of the convex portions 112 (hereinafter referred to as a top surface area), and the top surface area may be multiplied by the number of the convex portions 112 formed on the developer carrying surface to obtain the total area of the top surfaces of the convex portions 112.

Where the developer carrier is the developing roller 110, eight convex portions 112 may be selected from a center region and left and right end regions of the developing roller 110 (three regions of the developing roller 110), and maximum height differences thereof are measured. The average of the maximum height differences may be calculated as a height difference H of the convex portions 112 and the concave portions 114 (refer to FIG. 6B). Thereafter, 10% lower points may be determined to measure the top surface areas of the convex portions 112 and the total area of the top surfaces of the convex portions 112. The ratio of the total area of the top surfaces of the convex portions 112 to the area of the developer carrying surface may be calculated.

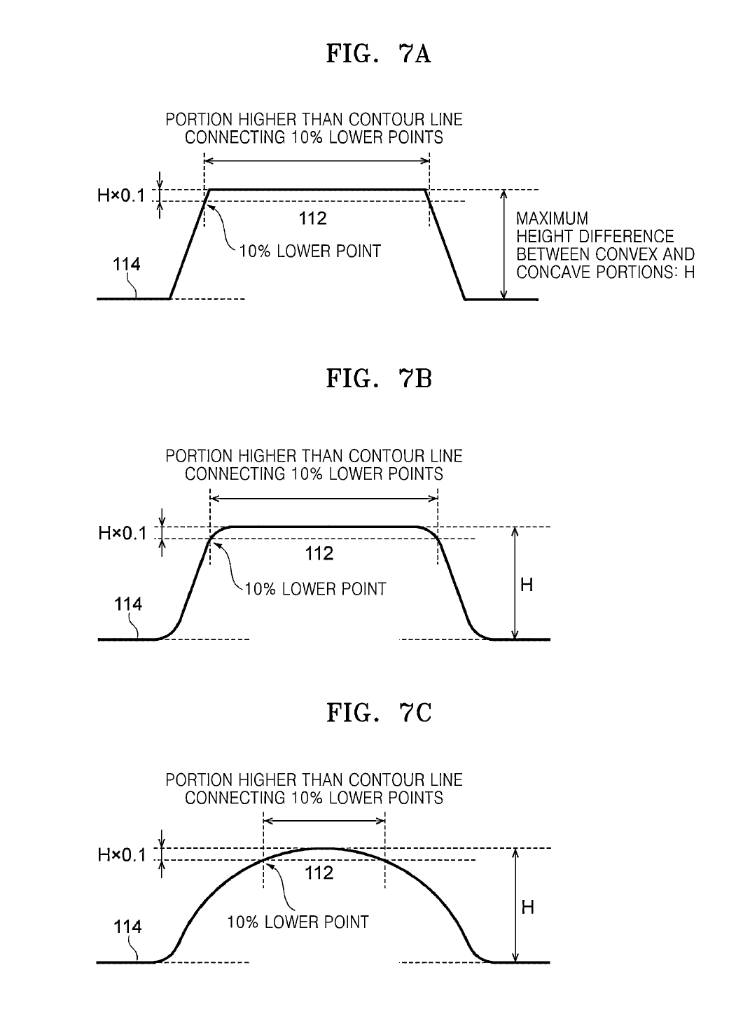

The height difference H and the ratio of the total area of the top surfaces may be obtained in a similar manner for the case where the convex portions 112 have a rounded shape (refer to FIGS. 7A to 7C).

The shape of the developer carrying surface of the developer carrier may be measured. For example, a non-contact type surface shape measuring apparatus or a surface measuring laser microscope may be used. Measured surface shape data may be analyzed by using an analysis tool included in such a measuring apparatus or a computer aided design (CAD) tool for geometrical analysis using drawings.

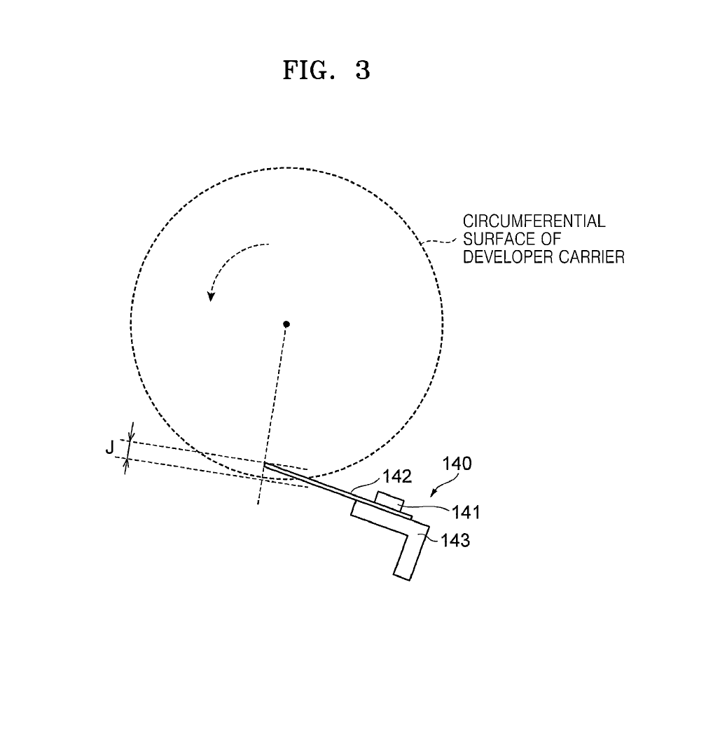

FIG. 3 is a view illustrating the elastic blade 140 as an example of a developer regulating member according to an embodiment. The elastic blade 140 includes a base 143, an elastic contact part 142, and a fixing member 141 supporting and fixing the elastic contact part 142 to the base 143.

The elastic contact part 142 has an end portion extending in a direction parallel with the axis of the developing roller 110. The end portion may be spaced apart from the bottom surfaces of the concave portions 114 of the developer carrying surface of the developing roller 110 by a distance (hereafter referred to as a gap from bottom surfaces) greater than the weight average particle diameter of toner T. If the gap from bottom surfaces is not greater than the weight average particle diameter of toner T, the developing roller 110 may not carry a sufficient amount of toner T, and errors may easily occur in vertical lines of images.

As illustrated in FIG. 3, the developer regulating member such as the elastic blade 140 may be brought into contact with the developer carrying surface by pressure, and along with this, the protruding amount of the developer regulating member may be varied, so as to form a thin layer that has a desired amount of developer (toner) on the developer carrying surface.

According to an exemplary embodiment, the protruding amount of the developer regulating member may be defined as a distance J between a pressing surface of the leading end of the developer regulating member and the outer surface of the developer carrier measured along an extension line passing through the rotation center of the developer carrier, the leading end of the developer regulating member, and the outer surface of the developer carrier. The protruding amount of the developer regulating member may be geometrically determined on a drawing using a tool such as a CAD tool.

The protruding amount of the developer regulating member may be obtained by actually measuring the distance to the leading end of the developer carrier from a contact trace between the developer regulating member and the developer carrier.

The elastic blade 140 regulates the thickness of a toner layer formed on the top surfaces of the convex portions 112 of the developing roller 110 to be equal to or smaller than the thickness of a single layer of a toner particle. That is, the elastic blade 140 prevents an excessive toner particles being carried on the top surfaces of the convex portions 112 of the developing roller 110. Accordingly a rolling motion of toner particles may be uniform and efficient along the developer carrying surface of the developing roller 110, thus all the toner particles may be properly charged. If toner particles are excessively carried on the top surfaces of the convex portions 112, the excessive toner particles may not be properly charged, and rolling motion of other toner particles may be obstructed by the excessive toner particles. That is, all the toner particles may not be properly charged.

A contact position S2 between the elastic blade 140 and the developing roller 110 may be lower than a contact position S1 between the developing roller 110 and the toner supply roller 120 (see, for example, FIG. 4). The elastic blade 140 regulates the layer thickness of toner T supplied from the toner supply roller 120 to the developing roller 110 before the toner T is supplied from the developing roller 110 to the photoconductor drum 30. By regulating the layer thickness of toner T, an excessive toner T carried on the developing roller 110 is scraped down to the toner collecting part 160 by the elastic blade 140. The agitating member 165 may be disposed in the toner collecting part 160 to agitate and mix the excessive toner T with toner T newly supplied from the toner containing chamber 130 for the next developing operation.

According to an exemplary embodiment, excessive developer scraped off the developing roller 110 by the elastic blade 140 is not directly collected in the toner containing chamber 130, but may be collected in the toner collecting part 160 disposed at a lower position in the developing chamber 150. Since excessive developer collected in the toner collecting part 160 is already charged with an appropriate potential, the excessive developer may be gradually compressed in a space formed from the barrier wall 170 forming the toner collecting part 160 to the contact position 51 between the developing roller 110 and the toner supply roller 120, and may be easily moved to the concave portions 114 of the developing roller 110 while maintaining a gradually compressed state owing to an electrostatic repulsive force therebetween.

In the developing device 100, the contact position S2 between the developing roller 110 and the elastic blade 140 may be set to be lower than the contact position 51 between the developing roller 110 and the toner supply roller 120 (that is, the contact position S2 is between the barrier wall 170 forming the toner collecting part 160 and the contact position 51), so as to circulate toner particles through the contact positions 51 and S2 by uniform and gradual pressure, allow toner to stably penetrate into the concave portions 114 of the developing roller 110, and increase the degrees of freedom of contact conditions (protruding amount) between the developing roller 110 and the elastic blade 140.

In the developing device 100, the protruding amount J of the elastic blade 140 with respect to the developing roller 110 may have a large dimensional tolerance, and thus although the contact portion of the elastic blade 140 wears down to vary the protruding amount J of the elastic blade 140 after a number of image forming processes, the possibility is high that the protruding amount J of the elastic blade 140 is still within a dimensional tolerance range. The contact portion of the elastic blade 140 may be designed so as to be less worn down for allowing self cleaning. For example, the elastic contact part 142 may be formed of a phosphor bronze or stainless steel plate member to obtain a surface hardness ratio of the elastic contact part 142 to the developing roller 110 within the range 0.20 to less than 1.00.

Therefore, toner particles may be maintained in a charged state and an appropriate carried state without faults such as filming of toner. As a result, the developing device 100 may reduce vertical stripe type image density stains, deterioration/variations in image density, contamination of non-image regions (corresponding to backgrounds) by toner, and deterioration/variations in session reproducibility and color tone.

In addition, if the developing device 100 is used in a process cartridge type image forming apparatus vulnerable to stress, the effects of the developing device 100 may be significant.

### EXAMPLES

Hereinafter, exemplary examples of are described in detail. However, the embodiments are not limited thereto.

### Developer Preparation Examples

### One-Component (Black) Developer Preparation Example

The following substances were dry-mixed and kneaded with a two-axis kneading machine.
Styrene-butyl acrylate resin (Mw=50,000, Tg=60° C.): 100 parts by mass
Carbon black (average particle diameter=40 nm): 5 parts by mass
Aluminum compound derived from salicylic acid (by Orient Chemical Industry Co., Ltd): 1 part by mass
Ester wax (maximum heat-absorption peak temperature in DSC (differential scanning calorimetry)=70° C.): 5 parts by mass

After the kneading, the mixture were cooled and coarsely pulverized to 1 mm or smaller. Thereafter, the mixture was finely pulverized using a mechanical pulverizer and classified to obtain classified particles.

Next, 100 parts by mass of the classified particles was inserted into a dry mixing device together with the following substances, and then a low RPM preliminary mixing and a 5-minute high RPM dry mixing were performed.
Hydrophobically-treated silica fine particles (number average particle diameter=0.1 μm): 0.5 parts by mass
Hydrophobically-treated silica fine particles (number average particle diameter=0.02 μm): 1.0 part by mass
Hydrophobically-treated titania fine particles (number average particle diameter=0.02 μm): 1.0 part by mass

After the dry mixing, coarse particles were removed from the mixture by using a sieve to obtain one-component black developer.

### One-Component (Yellow) Developer Preparation Example

One-component yellow developer was prepared in a similar manner as that used in the one-component (black) developer preparation example except that 7 parts by mass of “C.I. Pigment Yellow 180” was used instead of carbon black.

### One-Component (Magenta) Developer Preparation Example

One-component yellow developer was prepared in a similar manner as that used in the one-component (black) developer preparation example except that 7 parts by mass of “C.I. Pigment Red 180” was used instead of carbon black.

### One-Component (Cyan) Developer Preparation Example

One-component yellow developer was prepared in a similar manner as that used in the one-component (black) developer preparation example except that 5 parts by mass of “C.I. Pigment Blue 15:3” was used instead of carbon black.

In the examples, the weight average particle diameter D4 of the one-component developer or the number of toner particle having a size equal to or smaller than 3 μm in number-based particle diameter distribution of the one-component developer may be measured using a precise particle size distribution measurement device, for example, such as “Multisizer 3” (by Beckman Coulter) according to a manipulation manual thereof including a “toner particle diameter distribution measurement method” (see, for example, Beckman Coulter's website: <<http://www.beckmancoulterco.jp/product/product03/toner/04.html>>).

A toner suspension may be prepared by adding 0.1 g of a surfactant (sodium linear alkylbenzene sulfonate (LAS)) to 100 ml of an electrolyte “ISOTONE II PC” (for example, by Beckman Coulter) filled in a beaker and then adding 5 mg of a sample (toner particles or one-component developer) thereto. The toner suspension may be irradiated with ultrasonic waves for 2 minutes using an ultrasonic bath to disperse the sample more uniformly. The volume and number of sample may be measured at each channel using a 50 μm diameter aperture tube so as to calculate volume and number distributions of the sample. The weight average diameter D4 is obtained based on the calculated distributions.

In the examples, the prepared one-component color developers had a weight average particle diameter D4 of 6.5 μm, and a 3-μm or smaller particle content of 10% in number-based particle diameter distribution.

### Developer Carrier Fabrication Examples

### Developer Carrier Fabrication Example 1

The outer surface of a cylindrical roller base formed of a 16-mm diameter carbon steel pipe (hereinafter the outer surface will be referred to as a cylindrical surface) was polished using a centerless polishing machine, and the roller base was disposed in a rolling machine including first and second dies having threads corresponding to grooves so as to form two grooves crossing each other (as indicated by arrows A and B in FIG. 5B). While rotating the dies and the roller base at constant speeds and carrying the roller base, the dies were pushed against the roller base to form first and second grooves in the roller base.

As a result, a rolled roller was obtained in which convex portions and concave portions surrounding the convex portions were regularly formed on a cylindrical surface, and surfaces of the convex portions constituted portions of the cylindrical surface.

The cylindrical surface of the rolled roller was polished using a centerless polishing machine to adjust the height difference between the convex portions and the concave portions, and then the rolled roller was immersed in a heated degreasing liquid to remove grease.

The rolled roller was immersed in a nickel-phosphorus (Ni—P) plating bath to plate the cylindrical surface of the rolled roller by electroless plating, and then the roller was cleaned and dried. In this was, a developing roller (developer carrier T-1) having a developer carrying surface (see, for example, FIG. 5A) was fabricated.

The height difference between the convex portions and the concave portions formed on the cylindrical surface of the developer carrier T-1 was 12 μm, and the area percentage of the top surfaces of the convex portions was 11%. The developing roller had a Vickers hardness of 700 Hv.

### Developer Carrier Fabrication Examples 2 to 5

Developing rollers (developer carriers T-2 to T-5) having different height differences between convex portions and concave portions, area percentages of top surfaces of convex portions, and surface hardness were fabricated in a similar manner as that used in the developer carrier fabrication example 1 except for rolling conditions, polishing conditions for adjusting height differences between convex portions and concave portions, the concentration of phosphorus (P) in electroless plating, and heating conditions.

### Developer Carrier Fabrication Examples 6 and 7

Developing rollers (developer carriers E-1 and E-2) having different height differences between convex portions and concave portions, area percentages of top surfaces of convex portions, and surface hardness were fabricated in a similar manner as that used in the developer carrier fabrication example 1 except for cylindrical surface etching, the concentration of phosphorus (P) in electroless plating, and heating conditions.

### Comparative Developer Carrier Fabrication Examples 1 to 3

Comparative developing rollers (comparative developer carriers t-6 to t-8) having different height differences between convex portions and concave portions, area percentages of top surfaces of convex portions, and surface hardness were fabricated in a similar manner as that used in the developer carrier fabrication example 1 except for rolling conditions, polishing conditions for adjusting height differences of convex portions and concave portions, the concentration of phosphorus (P) in electroless plating, and heating conditions.

### Comparative Developer Carrier Fabrication Example 4

A comparative developing roller (developer carriers e-3) having a different height difference between convex portions and concave portions, an area percentage of top surfaces of convex portions, and a surface hardness were fabricated in a similar manner as that used in the developer carrier fabrication example 1 except for cylindrical surface etching, the concentration of phosphorus (P) in electroless plating, and heating conditions.

The developing rollers and the comparative developing rollers fabricated in the developer carrier fabrication examples 1 to 7 and the comparative developer carrier fabrication examples 1 to 4 are illustrated in Table 1 below.

TABLE 1

| | | | Ratio of total area | |
|---|---|---|---|---|
| | | Height | of top surfaces of | |
| | | difference | convex portions to | |
| | | between | total | |
| | | convex and | circumferential | |
| | | concave | area of developer | Surface |
| | | portions | carrier | hardness |
| | Developer carrier | (μm) | (%) | (Hv) |
| Developer carrier fabrication | Developer carrier | 12 | 11 | 700 |
| example 1 | T-1 | | | |
| Developer carrier fabrication | Developer carrier | 20 | 20 | 650 |
| example 2 | T-2 | | | |
| Developer carrier fabrication | Developer carrier | 5.2 | 4 | 900 |
| example 3 | T-3 | | | |
| Developer carrier fabrication | Developer carrier | 5.9 | 38 | 500 |
| example 4 | T-4 | | | |
| Developer carrier fabrication | Developer carrier | 31 | 3 | 950 |
| example 5 | T-5 | | | |
| Developer carrier fabrication | Developer carrier | 32 | 8 | 500 |
| example 6 | E-1 | | | |
| Developer carrier fabrication | Developer carrier | 26 | 32 | 950 |
| example 7 | E-2 | | | |
| Comparative developer carrier | Comparative | 21 | 43 | 440 |
| fabrication example 1 | dveloper carrier t-6 | | | |
| Comparative developer carrier | Comparative | 3.9 | 18 | 700 |
| fabrication example 2 | developer carrier t-7 | | | |
| Comparative developer carrier | Comparative | 18 | 2 | 1000 |
| fabrication example 3 | developer carrier t-8 | | | |
| Comparative developer carrier | Comparative | 35 | 25 | 700 |
| fabrication example 4 | developer carrier e-3 | | | |

### Example 1

An image forming apparatus was prepared by replacing a developing unit of an A3 color multi-function apparatus (MultiXpress CLX-9301 NA by Samsung Electronics Co., Ltd.) with the one-component developing unit-A1 illustrated in FIG. 4 and modifying/adjusting the A3 color multi-function apparatus to form images.

In the image forming apparatus, the developer carrier T-1 fabricated in the developer carrier fabrication example 1 was used as a developer carrier of a black developing unit, and a stainless steel thin plate (plate thickness=80 μm, Vickers hardness=350 Hv) was used as an elastic contact part of a developer regulating member. 150 g of black one-component developer prepared in the one-component (black) developer preparation example was used.

The height difference H of convex portions and concave portions of the developer carrier T-1 was 1.9 times the weight average particle diameter of developer, and the ratio of the surface hardness of a contact portion of the developer regulating member to the surface hardness of the developer carrier was 0.50.

[Evaluation of the Amount of Developer Regulated on the Developer Carrier According to the Protruding Amount of the Developer Regulating Member]

To evaluate the amount of developer regulated on the developer carrier (hereinafter referred to as a regulation amount) according to the protruding amount of the developer regulating member (hereinafter referred as a protruding amount), the regulation amount was measured according to the protruding amount at room temperature and humidity (23° C./50% Rh).

The protruding amount of the developer regulating member was adjusted using a dedicated jig, and the developer regulating member was installed. A solid image was printed, and the developing unit was operated for 15 seconds without consuming developer to stabilize the developer regulating state of the developer carrier. Thereafter, regulating amounts were measured. In the measurement of regulating amounts, a suction type charge amount measuring device was used.

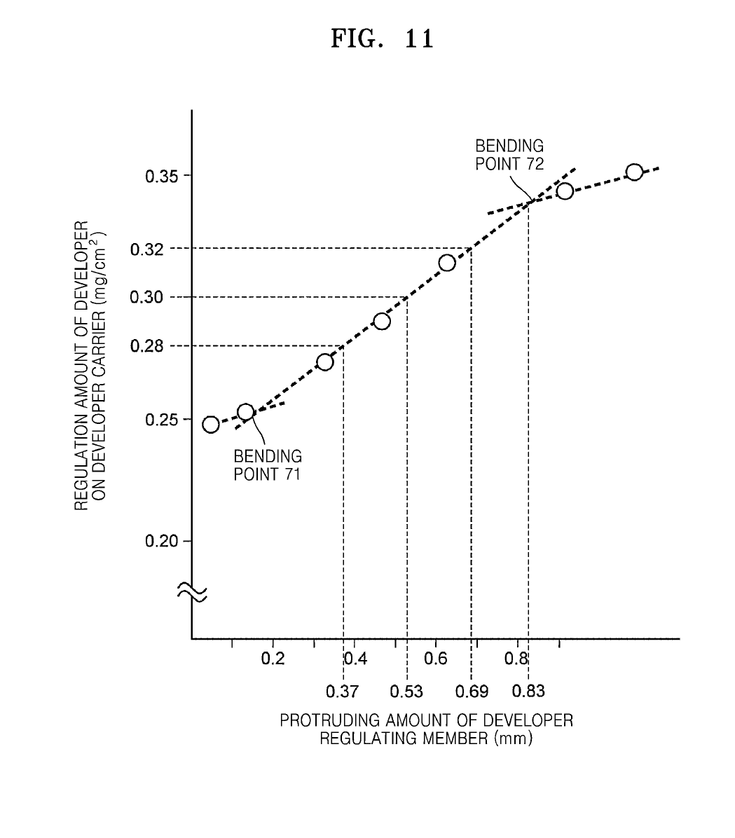

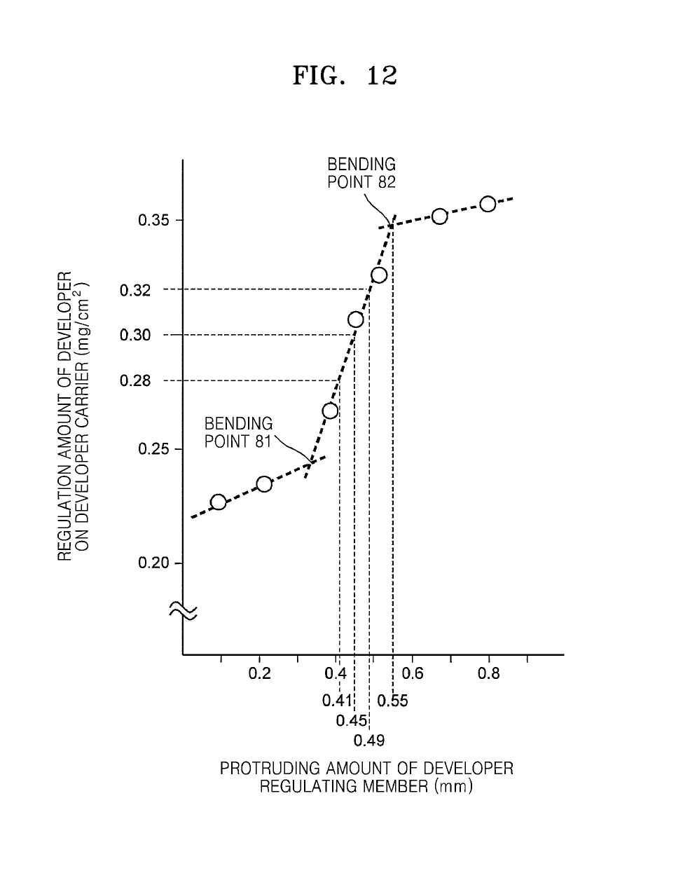

The results of measurement of the amount of developer regulated on the developer carrier are illustrated in FIG. 11 according to the protruding amount of the developer regulating member.

The amount of developer regulated on the developer carrier was increased in proportion to the protruding amount of the developer regulating member, and then a bending point 71 was present. As the protruding amount increased and reached 0.83 mm, another bending point 72 was present. The regulation amount of developer was 0.34 mg/cm², and developer particles were regulated to form a one-particle thickness or thinner layer on the top surfaces of the convex portions of the developer carrier. However, as the protruding amount was further increased, developer particles covered all the top surfaces of the convex portions of the developer carrier, to form a layer thicker than a single layer of a developer particle.

When the regulation amount of developer on the developer carrier was 0.30 mg/cm², the protruding amount of the developer regulating member was 0.53 mm, and when the allowable variation of the regulation amount of developer was set to ±0.02 mg/cm², the dimensional tolerance of the protruding amount was 0.32 mm (upper limit: 0.69 mm, lower limit: 0.37 mm). Thus, assembling may be easily performed even in mass production processes.

[Image Quality Evaluation]

After the regulation amount of developer on the developer carrier was adjusted to 0.30 mg/cm² at room temperature and humidity (23° C./55% Rh), black images were printed out on 30,000 sheets of paper in single color mode, and the qualities of the initially printed image and the last printed image were evaluated. In the printing, full color copy machine paper C2 (70 g/cm², A4) by Fuji Xerox was used as a transfer material.

From the start to end of the printing, printed images had satisfactory image quality, and reproducibility of small point text images was satisfactory. In addition, non-image regions were not or less contaminated with toner, and vertical stripe type image density stains caused by regulation stains of developer on the developer carrier were not observed.

After evaluation, the regulation amounts of developer were checked at several positions of the surface of the developer carrier, and the measured regulation amounts were within 0.30 mg/cm²±0.02 mg/cm². In addition, filming or sticking of developer was not observed on the surface of the developer carrier, and the surface condition of the developer carrier was appropriately maintained.

### Comparative Example 1

An evaluation test was performed in a similar manner as in Example 1 except that the regulation amount of developer on the developer carrier was 0.43 mg/cm² (developer particles covered all the convex portions of the developer carrier and formed a layer thicker than a single layer of a developer particle).

Since the regulation amount of developer was excessive, the charged state of the developer was insufficient, and although image density was sufficient at the start of printing, small point text images were not clear due to thick line widths and non-image regions were contaminated with toner. At the time of printing-out on 30,000 sheets of paper, image density was lowered, and non-image regions were contaminated much more with toner. In addition, vertical stripe type image density stains caused by regulation stains of developer on the developer carrier were observed, and the regulation amount of developer on the developer carrier was largely varied in the axis direction of the developer carrier.

### Comparative Example 2

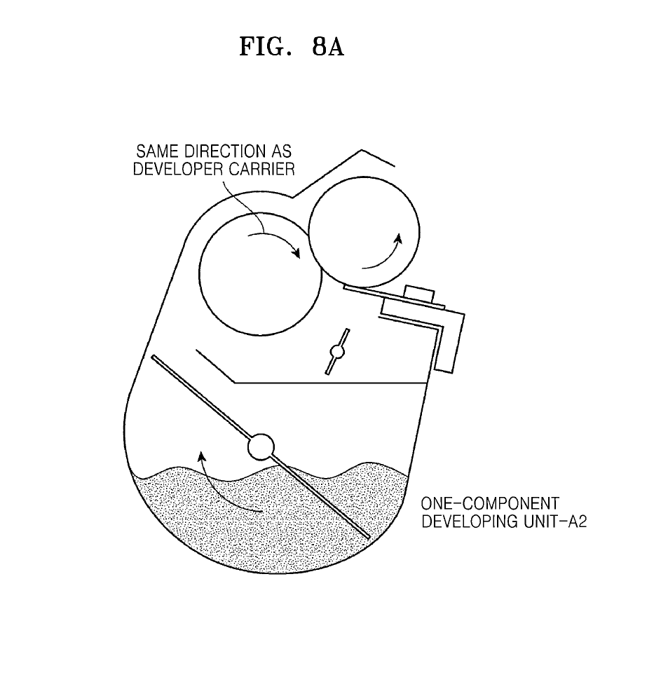

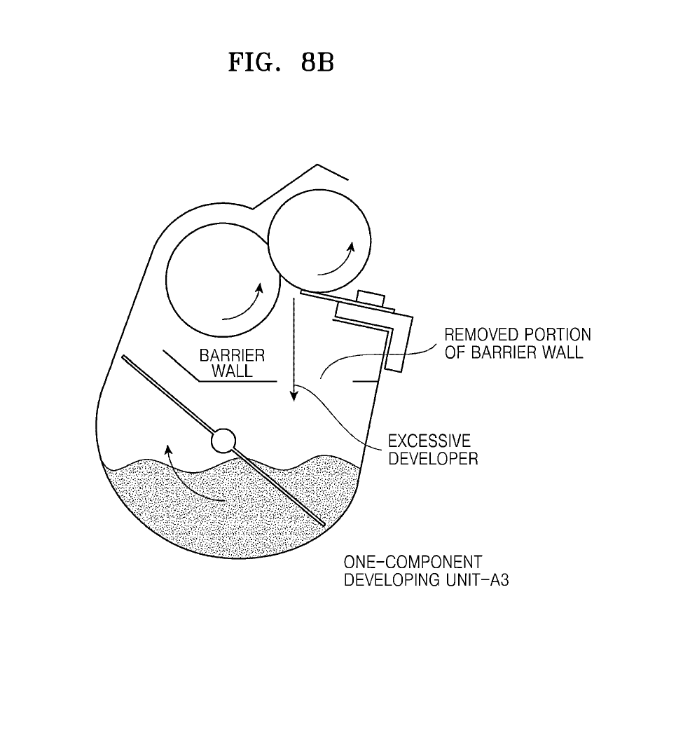

An evaluation test was performed in a similar manner as in Example 1 except that the one-component developing unit-A1 was replaced with a one-component developing unit-A2 illustrated in FIG. 8A in which a developer supply part and a developer carrier were configured to rotate in a manner such that the developer supply part and the developer carrier move in a similar direction at a contact position therebetween.

FIG. 12 illustrates bending points 81 and 82. Since the developer supply part and the developer carrier move in a similar direction at a contact position therebetween, the regulation amount of developer on the developer carrier was steeply increased in proportion to the protruding amount, and a bending point 82 was present when the protruding amount was 0.55 mm (see, for example, FIG. 12).

When the regulation amount of developer on the developer carrier was 0.30 mg/cm², the protruding amount of a developer regulating member was 0.45 mm, and when the allowable variation of the regulation amount of developer was set to ±0.02 mg/cm², the dimensional tolerance of the protruding amount was only 0.08 mm (upper limit: 0.49 mm, lower limit: 0.41 mm). Thus, assembling may not be easy in mass production processes.

An image quality evaluation was performed like in Example 1. Since the developer supply part and the developer carrier are moved in a similar direction at a contact position therebetween, old developer was inefficiently replaced with new developer, and developer particles were packed in concave portions of the developer carrier. Therefore, frictional charging by rolling motion of developer particles were obstructed, image density was low from the start of printing, and non-image regions were contaminated with toner. In addition, vertical stripe type image density stains caused by regulation stains of developer on the developer carrier were observed at a plurality of positions, and this became worse as printing proceeded.

After evaluation, the regulation amount of developer on the developer carrier was measured to be largely varied in the axis direction of the developer carrier.

### Comparative Example 3

An evaluation test was performed in a similar manner as in Example 1 except that the one-component developing unit-A1 was replaced with a one-component developing unit-A3 illustrated in FIG. 8B in which a portion of a barrier wall between a developer containing chamber and a developing chamber was removed to collect excessive developer regulated by a developer regulating member directly in the developer containing chamber.

Since a portion of the barrier wall between the developer containing chamber and the developing chamber was removed to collect excessive developer regulated by the developer regulating member directly in the developer containing chamber, the regulation amount of developer on a developer carrier was steeply increased in proportion to the protruding amount, and a second bending point was present when the protruding amount was 1.10 mm.

When the regulation amount of developer on the developer carrier was 0.30 mg/cm², the protruding amount of the developer regulating member was 0.81 mm, and when the allowable variation of the regulation amount of developer was set to ±0.02 mg/cm², the dimensional tolerance of the protruding amount was only 0.05 mm. Thus, assembling may not be easy in mass production processes.

Image quality evaluation was performed as in Example 1. Since a portion of the barrier wall between the developer containing chamber and the developing chamber was removed to collect excessive developer regulated by the developer regulating member directly in the developer containing chamber, the amount of developer supplied from the developer carrier was unstable, and thus image density was low from the start of printing and small point text images were not properly reproduced. Vertical stripe type image density stains caused by regulation stains of developer on the developer carrier were observed at a plurality of positions, and this became worse as printing proceeded.

After evaluation, the regulation amount of developer on the developer carrier was measured to be largely varied in the axis direction of the developer carrier.

### Comparative Example 4

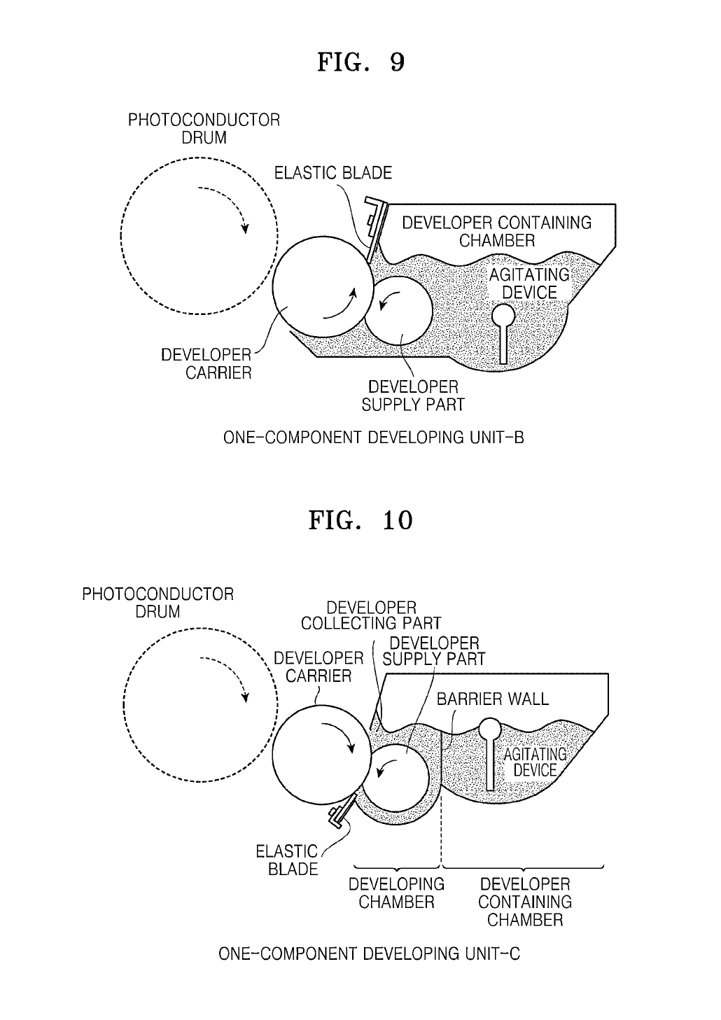

An evaluation test was performed in a similar manner as in Example 1 except for the followings: A3 color printer “Color Laser Jet 5550 (by Hewlett-Packard)” was used as an image forming apparatus; the developer carrier T-1 obtained in the developer carrier fabrication example 1 was used as a developer carrier of a toner cartridge; a stainless steel thin plate (thickness=80 μm, Vickers hardness=350 Hv) was used as an elastic contact part of a developer regulating member; a gap between the developer regulating member and an electrostatic latent image carrier was modified/adjusted to be 200 μm (refer to a one-component developing unit-B illustrated in FIG. 9 in which a contact position between a developer carrier and a developer regulating member is higher than a contact position between the developer carrier and a developer supply part, and excessive developer regulated by the developer regulating member is collected directly in a developing chamber), and 280 g of one-component black developer prepared in the one-component (black) developer preparation example was used.

Since the contact position between the developer carrier and the developer regulating member was higher than the contact position between the developer carrier and the developer supply part and excessive developer regulated by the developer regulating member was directly collected in the developer containing chamber, the regulation amount of developer on a developer carrier was steeply increased in proportion to the protruding amount, and a second bending point was present when the protruding amount was 0.90 mm.

When the regulation amount of developer on the developer carrier was 0.30 mg/cm², the protruding amount of the developer regulating member was 0.61 mm, and when the allowable variation of the regulation amount of developer was set to ±0.02 mg/cm², the dimensional tolerance of the protruding amount was only 0.04 mm. Thus, assembling may not be easy in mass production processes.

Image quality evaluation was performed like in Example 1. Since the contact position between the developer carrier and the developer regulating member was higher than the contact position between the developer carrier and the developer supply part and excessive developer regulated by the developer regulating member was collected directly in the developer containing chamber, non-image regions were contaminated with toner even though image density was sufficient at the start of printing. Although contamination of non-image regions by toner was temporarily reduced as printing proceeded, contamination of non-image regions became worse when toner was refilled, and at the time of printing-out on 30,000 sheets of paper, image density was lowered. In addition, vertical stripe type image density stains were caused by regulation stains of developer on the developer carrier.

### Comparative Example 5

An evaluation test was performed in a similar manner as in Comparative Example 4 except for modification/adjustment for using a one-component developing unit-C illustrated in FIG. 10 as a developing unit, in which a developer supply part was rotated in a manner such that the developer supply part moves in the same direction as a developer carrier, and excessive developer regulated by a developer regulating member was collected in a developer collecting part formed at an upper position in a developing chamber.

Since the developer supply part was rotated in a manner such that the developer supply part moves in the same direction as the developer carrier and excessive developer regulated by a developer regulating member was collected in the developer collecting part formed at the upper position in the developing chamber, the regulation amount of developer on a developer carrier was steeply increased in proportion to the protruding amount, and a second bending point was present when the protruding amount was 0.88 mm.

When the regulation amount of developer on the developer carrier was 0.30 mg/cm², the protruding amount of the developer regulating member was 0.85 mm, and when the allowable variation of the regulation amount of developer was set to ±0.02 mg/cm², the dimensional tolerance of the protruding amount was only 0.04 mm. Thus, assembling may not be easy in mass production processes.

Image quality evaluation was performed as in Example 1. Since the developer supply part was rotated in a manner such that the developer supply part moves in the same direction as the developer carrier and excessive developer regulated by a developer regulating member was collected in the developer collecting part formed at the upper position in the developing chamber, non-image regions were contaminated with toner from the start of printing. In addition, as printing proceeded, image density or reproducibility of small point text images were markedly lowered, and a plurality of vertical stripe type image density stains were observed due to regulation stains of developer on the developer carrier.

After evaluation, the regulation amount of developer on the developer carrier was largely varied in the axis direction of the developer carrier.

The configurations of the developing units used in Example 1 and Comparative Examples 1 to 5 are illustrated in Table 2, and evaluation results are illustrated in Table 3. Evaluation references in Table 3 are as follows.

[1. Assembling Characteristics of Developer Regulating Member]

In a case where the regulation amount of developer on the developer carrier was 0.03 mg/cm² and an allowable variation of the regulation amount was ±0.02 mg/cm², the dimensional tolerance of the protruding amount of each developer regulating member was obtained and evaluated according to the following references:
A: dimensional tolerance is 0.3 mm or greater (very easy)
B: dimensional tolerance is from 0.2 mm to less than 0.3 mm (easy)
C: dimensional tolerance is from 0.1 mm to less than 0.2 mm (allowable in an embodiment)
D: dimensional tolerance is less than 0.1 mm (difficult and not allowable in an embodiment)

[2. Image Density]

An image having 5-mm square solid patches at four corners and a center region thereof was printed, and reflection density of the solid patches was measured using a spectrophotometer “Spectroeye (by Gretag-Macbeth).” An average of measured values was calculated and evaluated according to the following references:
A: 1.30 or greater (very good)
B: From 1.15 to less than 1.30 (good)
C: from 1.00 to less than 1.15 (allowable in an embodiment)
D: less than 1.00 (not allowable in an embodiment)

[3. Reproducibility Small Point Text Images]

5-point text images were printed at four corners and a center region, and reproducibility of the images were evaluated according to the following references:
A: thin line width variation is less than 10% (very good)
B: thin line width variation is from 10% to less than 15% (good)
C: thin line variation is 15% or greater and observable with the naked eye (allowable in an embodiment)
D: thin line contacts, cuts, or splits are easily observable with the naked eye (not allowable in an embodiment)

[4. Contamination of Non-Image Regions (Background) by Toner]

In a case of forming a white image, developer existing on a photoconductor drum between a developing process and a transfer process was transferred to an adhesive surface of mending tape (by Sumimoto 3M). The mending tape with the developer was attached to paper, and the reflection density thereof was measured using a spectrophotometer “Spectroeye (by Gretag-Macbeth).” A (blank) reflection density value measured from mending tape attached to paper was subtracted from the measured reflection density, and a value obtained by the subtraction was evaluated according to the following references. As the value is low, the degree of contamination of non-image regions by toner is low.
A: 0.03 or less (very good)
B: from 0.03 to less than 0.07 (good)
C: from 0.07 to less than 1.00 (allowable in an embodiment)
D: 1.00 or greater (not allowable in an embodiment)

[5. Image Density Unevenness in the Form of Vertical Stripes]

Halftone image formed of dots was printed, and the number of stripe type image density stains in the printed halftone image was measured and evaluated according to the following references:
A: none (very good)
B: a slight vertical stripe type image density strain (good)
C: two to four vertical stripe type image density stains (allowable an embodiment)
D: 5 or more vertical stripe type image density stains (not allowable in an embodiment)

TABLE 2

| | | Rotation | | |
|---|---|---|---|---|
| | | direction of | | |
| | | developer | Contact position between | |
| | | supply part | developer carrier and | |
| | | relative to | developer regulating | |
| | | movement | member relative to | |
| | | direction of | contact position between | |
| | | developer | developer carrier and | Collection place of |
| | Developing unit | carrier | developer supply part | excessive developer |
| Example 1 | One-component | Opposite | Lower | Developer collecting |
| | developing unit-A1 | | | part at a lower position |
| | | | | in developing chamber |
| Comparative | One-component | Same | Lower | Developer collecting |
| Example 2 | developing unit-A2 | | | part at a lower position |
| | | | | in developing chamber |
| Comparative | One-component | Opposite | Lower | Developer containing |
| Example 3 | developing unit-A3 | | | chamber |
| Comparative | One-component | Opposite | Higher | Developer containing |
| Example 4 | developing unit-B | | | chamber |
| Comparative | One-component | Same | Lower | Developer collecting |
| Example 5 | developing unit-C | | | part at an upper |
| | | | | position in developing |
| | | | | chamber |

TABLE 3

| | Evaluation of regulation | | | | |
|---|---|---|---|---|---|
| | amount of developer on | | | | |
| | developer carrier with | | | | |
| | respect to protruding | | | | |
| | amount of developer | Image quality evaluation | | | |
| | regulating member | (beginning of printing/when printing on 30,000th sheets) | | | |
| | Assembling | | | | Image density |
| | characteristics of | | Reproducibility | | stains caused |
| | developer regulating | Image | of small point | Contamination | by regulation |
| | member | density | text image | of background | stains |
| Example 1 | A | A/A | A/A | A/A | A/A |
| Comparative | D | A/B | C/B | B/D | A/D |
| Example 1 | | | | | |
| Comparative | D | C/D | C/D | C/D | B/D |
| Example 2 | | | | | |
| Comparative | D | D/D | D/D | A/B | C/D |
| Example 3 | | | | | |
| Comparative | D | A/B | B/C | D/C | B/D |
| Example 4 | | | | | |
| Comparative | D | B/D | C/D | D/C | C/D |
| Example 5 | | | | | |

### Example 2

An evaluation test was performed in a similar manner as in Example 1 except that the developer carrier T-2 fabricated in the developer carrier fabrication example 2 was used. The height difference H of convex portions and concave portions of the developer carrier T-2 was 3.1 times the weight average particle diameter of developer, and the ratio of the surface hardness of a contact portion of the developer regulating member to the surface hardness of the developer carrier was 0.54.

According to results of the evaluation test, assembling characteristics of the developer regulating member or printed images were satisfactory, and the surface condition of the developer carrier was appropriately maintained.

### Example 3

An evaluation test was performed in a similar manner as in Example 1 except that the developer carrier T-3 fabricated in the developer carrier fabrication example 3 was used. The height difference H of convex portions and concave portions of the developer carrier T-3 was 0.8 times the weight average particle diameter of developer, and the ratio of the surface hardness of a contact portion of the developer regulating member to the surface hardness of the developer carrier was 0.39.

According to results of the evaluation test, assembling characteristics of the developer regulating member or printed images were satisfactory, and the surface condition of the developer carrier was appropriately maintained.

### Example 4

An evaluation test was performed in a similar manner as in Example 1 except that the developer carrier T-4 fabricated in the developer carrier fabrication example 4 was used, and a phosphor bronze thin plate (thickness=100 μm, Vickers hardness=190 Hv) was used as an elastic contact part of a developer regulating member. The height difference H of convex portions and concave portions of the developer carrier T-4 was 0.9 times the weight average particle diameter of developer, and the ratio of the surface hardness of a contact portion of the developer regulating member to the surface hardness of the developer carrier was 0.38.

According to results of the evaluation test, assembling characteristics of the developer regulating member or printed images were satisfactory, and the surface condition of a developing roller was appropriately maintained.

### Example 5

An evaluation test was performed in a similar manner as in Example 1 except that the developer carrier T-5 fabricated in the developer carrier fabrication example 5 was used. The height difference H of convex portions and concave portions of the developer carrier T-5 was 4.8 times the weight average particle diameter of developer, and the ratio of the surface hardness of a contact portion of the developer regulating member to the surface hardness of the developer carrier was 0.37.

According to results of the evaluation test, assembling characteristics of the developer regulating member or printed images were satisfactory, and the surface condition of the developer carrier was appropriately maintained.

### Example 6

An evaluation test was performed in a similar manner as in Example 1 except that the developer carrier E-1 fabricated in the developer carrier fabrication example 6 was used, and a stainless steel thin plate (thickness=70 μm, Vickers hardness=450 Hv) was used as an elastic contact part of a developer regulating member. The height difference H of convex portions and concave portions of the developer carrier E-1 was 4.9 times the weight average particle diameter of developer, and the ratio of the surface hardness of a contact portion of the developer regulating member to the surface hardness of the developer carrier was 0.90.

According to the evaluation test, although the convex portions of the developer carrier were deformed by abrasion and developer particles were slightly stuck, assembling characteristics of the developer regulating member or printed images were satisfactory.

### Example 7

An evaluation test was performed in a similar manner as in Example 1 except that the developer carrier E-2 fabricated in the developer carrier fabrication example 7 was used, and a phosphor bronze thin plate (thickness=120 μm, Vickers hardness=150 Hv) was used as an elastic contact part of a developer regulating member. The height difference H of convex portions and concave portions of the developer carrier E-2 was 4.0 times the weight average particle diameter of developer, and the ratio of the surface hardness of a contact portion of the developer regulating member to the surface hardness of the developer carrier was 0.20.

According to the evaluation test, although slight filming of developer particles was observed on the developing roller, assembling characteristics of the developer regulating member or printed images were satisfactory.

### Comparative Example 6

An evaluation test was performed in a similar manner as in Example 1 except that the developer carrier t-6 fabricated in the comparative developer carrier fabrication example 1 was used, and a stainless steel thin plate (thickness=70 μm, Vickers hardness=440 Hv) was used as an elastic contact part of a developer regulating member. The height difference H of convex portions and concave portions of the developer carrier t-6 was 3.2 times the weight average particle diameter of developer, and the ratio of the surface hardness of a contact portion of the developer regulating member to the surface hardness of the developing roller was 1.02.

Before the evaluation test, the regulation amount of developer on the developer carrier was observed as being largely varied in the axis direction of the developer carrier because the area percentage of top surfaces of convex portions of the developer carrier was 40% or greater (43%), even though assembling characteristics of the developer regulating member were satisfactory.

From the start of printing, printed images had density stains caused by unevenly regulated developer, and backgrounds were contaminated. That is, sufficient image quality was not obtained. In addition, since the surface hardness ratio of a contact portion of the developer regulating member to the developer carrier was 1.00 or greater, the convex portions of the developer carrier were significantly worn down, and developer particles were sticked, to lower the quality of printed images.

### Comparative Example 7

An evaluation test was performed in a similar manner as in Example 1 except that the developer carrier t-7 fabricated in the developer carrier fabrication example 2 was used. The height difference H of convex portions and concave portions of the developer carrier t-7 was 0.6 times the weight average particle diameter of developer, and the ratio of the surface hardness of a contact portion of the developer regulating member to the surface hardness of the developer carrier was 0.50.

According to the evaluation test, since the height difference H of convex portions and concave portions of the developing roller was smaller than 0.8 times the weight average particle diameter of developer, assembling characteristics of the developer regulating member were not satisfactory, and non-image regions of printed images were contaminated with toner from the start of printing. That is, sufficient image quality was not obtained.

### Comparative Example 8

An evaluation test was performed in a similar manner as in Example 1 except that the developer carrier t-8 fabricated in the comparative developer carrier fabrication example 3 was used, and a phosphor bronze thin plate (thickness=120 μm, Vickers hardness=150 Hv) was used as an elastic contact part of a developer regulating member. The height difference H of convex portions and concave portions of the developer carrier t-8 was 2.8 times the weight average particle diameter of developer, and the ratio of the surface hardness of a contact portion of the developer regulating member to the surface hardness of the developing roller was 0.15.

In the evaluation test, printed images had satisfactory quality at the start of printing. However, as printing proceeded, the quality of printed images worsened. In addition, since the surface hardness ratio of a contact portion of the developer regulating member to the developer carrier was less than 0.20, filming of developer particles was observed on the developing roller, and thus the quality of printed images was directly lowered.

### Comparative Example 9

An evaluation test was performed in a similar manner as in Example 1 except that the developer carrier e-3 fabricated in the developer carrier fabrication example 4 was used. The height difference between convex portions and concave portions of the developer carrier e-3 was 5.4 times the weight average particle diameter of developer.

Before the evaluation test, the regulation amount of developer on the developer carrier was observed as being largely varied in the axis direction of the developer carrier because the height difference between convex portions and concave portions of the developer carrier was 5.0 or more times the weight average particle diameter of developer, even though assembling characteristics of a developer regulating member were satisfactory.

At the start of printing, printed images had satisfactory density and small point text reproducibility. However, image density stains caused by unevenly regulated developer were observed, and non-image regions were contaminated with toner. That is, sufficient image quality was not obtained.

Evaluation results of Examples 2 to 7 and Comparative Examples 6 to 9 are illustrated in Table 4 below.

TABLE 4

| | Evaluation of regulation | | | | |
|---|---|---|---|---|---|
| | amount of developer on | | | | |
| | developer carrier with | | | | |
| | respect to protruding | | | | |
| | amount of developer | Image quality evaluation | | | |
| | regulating member | (beginning of printing/when printing on 30,000th sheets) | | | |
| | Assembling | | | | Image density |
| | characteristics of | | Reproducibility | | stains caused |
| | developer regulating | Image | of small point | Contamination | by regulation |
| | member | density | text image | of background | stains |
| Example 2 | A | A/A | A/B | A/B | A/A |
| Example 3 | C | B/C | B/C | A/A | A/B |
| Example 4 | C | C/C | C/C | A/A | A/A |
| Example 5 | B | A/B | B/C | C/B | B/C |
| Example 6 | B | B/B | B/C | C/B | B/C |
| Example 7 | C | B/C | B/C | B/C | C/C |
| Comparative | C (Image density strains | C/D | D/C | D/D | D/D |
| Example 6 | at beginning of printing) | | | | |
| Comparative | D | C/D | C/D | D/C | C/D |
| Example 7 | | | | | |
| Comparative | D | B/C | C/D | C/B | C/D |
| Example 8 | | | | | |
| Comparative | C (Image density strains | B/C | B/C | D/D | D/D |
| Example 9 | at beginning of printing) | | | | |

### Example 8

In addition to the black developing unit, the other developing units of the image forming apparatus used in Example 1 were replaced with one-component developing units-A1 (see, for example, FIG. 4), and the image forming apparatus was adjusted/modified to form images. One-component black, yellow, magenta, and cyan developers obtained in the developer preparation examples were filled in the corresponding developing units, 150 g of each developer for each developing unit. The developer carrier T-1 fabricated in the developer carrier fabrication example 1 was used as a developer carrier, and a stainless thin plate (plate thickness=80 μm, Vickers hardness=350 Hv) was used as an elastic contact part of a developer regulating member.

The height difference of convex portions and concave portions of the developer carrier T-1 was 1.9 times the weight average particle diameter of developer, and the ratio of the surface hardness of a contact portion of the developer regulating member to the surface hardness of the developer carrier was 0.50.

The amount of developer on the developer carrier of each color developing unit was regulated like in Example 1, and while supplying developer, color images were printed on 10,000 sheets of paper in full color mode. Then, printed image quality was evaluated at the start and end of the printing. In the printing, full color copy machine paper C2 (70 g/cm², A4) by Fuji Xerox was used as a transfer material.

According to the evaluation test, assembling characteristics of the developer regulating member and printed images were satisfactory, and image density and reproducibility of small point text images were satisfactory from the start to end of the printing. In addition, non-image regions were not or less contaminated with toner, and vertical stripe type image density stains were not caused by regulation stains of developer on the developer carrier. That is, satisfactory full color images were obtained.

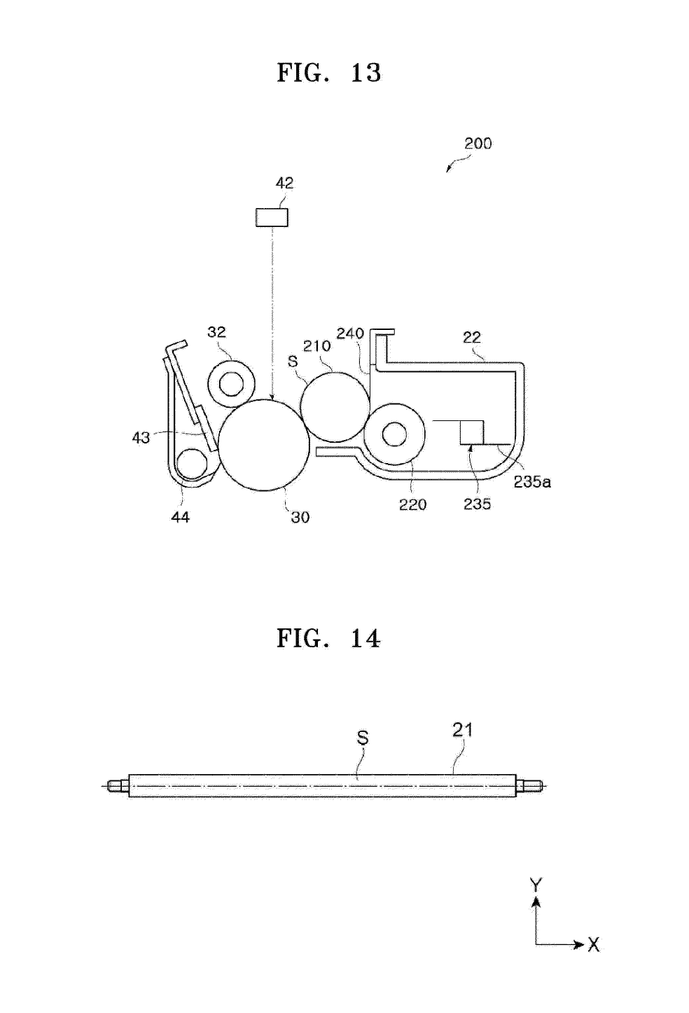

FIG. 13 illustrates a developing device 200 according to an embodiment of the present invention. Referring to FIG. 13, according to an embodiment of the present invention, the developing device 200 may be used in an image forming apparatus such as a laser beam printer. For example, the image forming apparatus including the developing device 200 are used to form color images using magenta, yellow, cyan, and black colors. The image forming apparatus includes a recording medium carrying unit configured to feed paper, a transfer unit configured to secondarily transfer a toner image to paper, a photoconductor drum 30 being an electrostatic latent image carrier on which an image is to be formed, a fusing unit configured to attach a toner image to paper, as well as the developing device 200 including a developing roller 210.

If an image signal of an image to be formed is input to the image forming apparatus, a controller of the image forming apparatus signals a charging roller to uniformly charge the surface of the photoconductor drum 30 with a predetermined potential based on the image signal. Thereafter, an exposing unit 42 emits laser light to the surface of the photoconductor drum 30 to form an electrostatic latent image on the photoconductor drum 30.

In the developing unit 200, a toner supply roller 220 supplies toner from a developing chamber to the developing roller 210. If the toner is carried to a region facing the photoconductor drum 30 as the developing roller 210 rotates, the toner starts to move from the developing roller 210 to the electrostatic latent image formed on the circumferential surface of the photoconductor drum 30, thereby developing the electrostatic latent image. A toner image may be transferred from the photoconductor drum 30 to a transfer belt in a region where the photoconductor drum 30 and the transfer belt face each other. Toner images formed on four photoconductor drums 30 are sequentially transferred to the transfer belt to form a stacked toner image. The stacked toner image is secondarily transferred to paper which is carried by the recording medium carrying unit. Thereafter, the paper on which the toner image is secondarily transferred may be carried to the fusing unit for fusing the toner image onto the paper, and the paper may be discharged to the outside of the image forming apparatus.

As illustrated in FIG. 13, the developing unit 200 includes the toner supply roller (toner supply part) 220, an elastic blade (developer regulating member) 240 and the developing roller 210.

The toner supply roller 220 may be installed to supply toner to the developing roller 210. For example, a portion of the toner supply roller 220 makes contact with the developing roller 210. Toner supplied by an agitating member 235 may be attached to the toner supply roller 220, and as the surface of the toner supply roller 220 makes contact with a surface (S) of the developing roller 210, the toner is supplied from the toner supply roller 220 to the developing roller 210 and the developing roller 210 carries the toner. Since the surface (S) of the toner supply roller 220 may be formed of an elastic member, toner may be appropriately supplied to the developing roller 210 when the toner supply roller 220 is brought into contact with the developing roller 210. While the toner supply roller 220 supplies toner, the toner supply roller 120 also scrapes toner, used for developing and passed a developing nip formed on the photoconductor drum 30, from the developing roller 210, thereby preventing an increase in charging amount caused by toner remaining on the developing roller 210 for a long period of time.

The elastic blade 240 makes contact with the developing roller 210 to regulate the amount of toner on the developing roller 210. A portion of the elastic blade 240 makes contact with the surface (S) of the developing roller 210. Since the surface (S) of the developing roller 210 rotates while making contact with the elastic blade 240, excessive toner may be scraped down from the developing roller 210. As a result, toner may only be retained in grooves of the developing roller 210 but may not be retained on top surfaces of the developing roller 210, and thus toner may be minimally stressed by the elastic blade 240. Since the grooves are regularly formed, toner may only be filled in the grooves, and thus the amount of toner per unit area of the developing roller 210 may be uniform.

In a toner tank 22, the agitating member 235 moves toner toward the left side in FIG. 13 to supply the toner to the developing roller 210 through the toner supply roller 220. Wing members 235a are attached to axial portions of the agitating member 235 and are configured to rotate around the agitating member 235.

As illustrated in FIG. 14, the developing roller 210 may have a long cylindrical shape, and toner may be carried on the surface (S) of the developing roller 210. In the following description of the developing roller 210, the rotation axis direction of the developing roller 210 is referred to as an x-axis direction, and the rotation direction of the developing roller 210 is referred to as a y-axis direction.

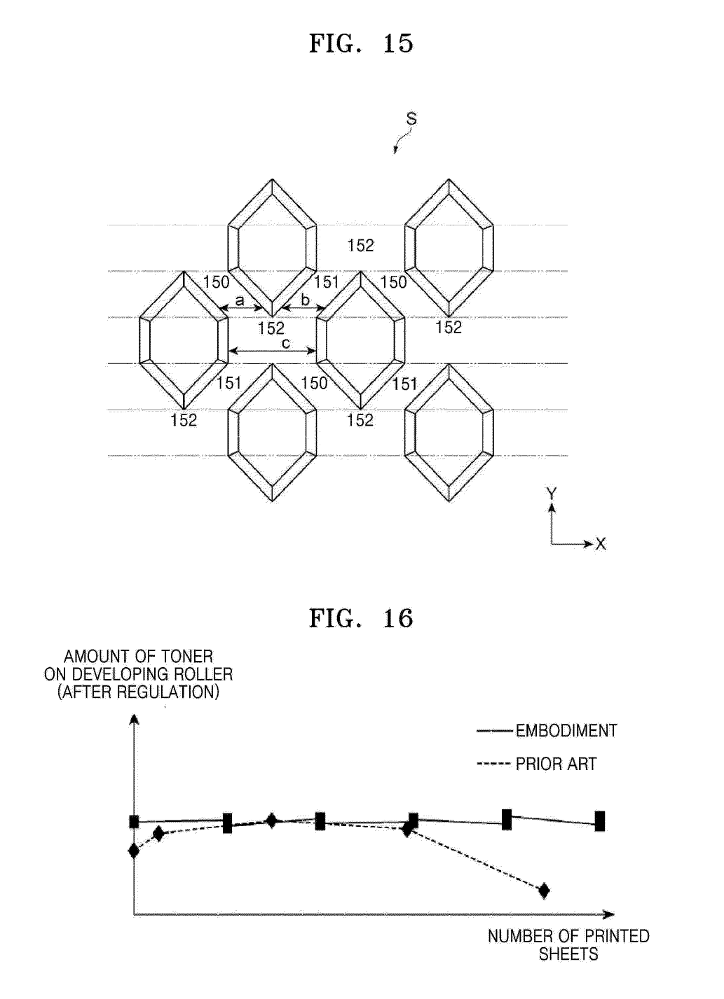

FIG. 15 illustrates a portion of the surface (S) of the developing roller 210. Referring to FIG. 15, a plurality of concave and convex portions are formed on the surface (S) of the developing roller 210, and toner is carried in the concave portions of the surface (S) of the developing roller 210. The concave portions of the surface (S) of the developing roller 210 includes first concave portions 150 extending in a direction making an angle of about 45′ from the y-axis direction second concave portions 151 extending in a direction making an angle of about 90° with the extending direction of the first concave portions 150, and third concave portions 152 continuous from the concave portions 150 and 151 and extending in the y-axis direction. Since the surface (S) of the developing roller 210 includes the first and second concave portions 150 and 151 making angles with the y-axis direction and the third concave portions 152 continuous from the first and second concave portions 150 and 151 and extending in the y-axis direction, a plurality of hexagonal convex portions symmetric with respect to the x-axis direction and the y-axis direction are formed.

Since the developing unit 200 includes the third concave portions 152, the widths of the concave portions are less varied along the rotation positions of the developing roller 210, and thus the amount of toner on the developing roller 210 and the density of images may not deviate greatly. Since the third concave portions 152 extend in the y-axis direction, toner may easily move in the y-axis direction, and thus stagnation of toner may reduce. Therefore, errors may not be caused by toner stagnation, and thus image quality may be improved. As illustrated in FIG. 16, in a case of a developing roller, if an image forming apparatus is used for a long time and the number of printed pages increases, the amount of toner filled on the developing roller may be reduced to cause filming of toner. However, in the developing roller 210 of the embodiment, although the number of printed pages increases, the amount of toner filled on the developing roller 210 is not reduced, and phenomena such as toner filming does not occur. Therefore, the lifespan of the image forming apparatus may be increased.

In addition, as illustrated in FIG. 15, the first to third concave portions 150 to 152 may satisfy the inequality: 0.7≦c/(a+b)≦1.4 where a denotes the width of each the first concave portions 150 in the x-axis direction, b denotes the width of each of the second concave portions

151 in the x-axis direction, and c denotes the width of each of the third concave portions 152 in the x-axis direction. Therefore, since the sum (a+b) of the widths of the first and second concave portions 150 and 151 sloped with respect to the y-axis direction is similar to the width (c) of the third concave portions 152 extending in the y-axis direction, the amounts of toner filled in the first to third concave portions 150, 151, and 152 may be uniform along the rotation positions of the developing roller 210. In addition, if a, b, and c satisfy 0.9≦c/(a+b)≦1.2, since the sum (a+b) of the widths of the first and second concave portions 150 and 151 is much similar to the widths (c) of the third concave portions 152, the amounts of toner filled therein may be more uniform.

Furthermore, in a section of the developing roller 210 taken in the x-axis direction, the sum of the widths (a) and (b) of the first and second concave portions 150 and 151 may be approximately equal to the width (c) of the third concave portions 152. In this case, although the rotation position of the developing roller 210 is varied, the amounts of toner filled in the first to third concave portions 150 to 152 may not be varied, and thus image density deviation may be surely prevented to improve the quality of images much more.

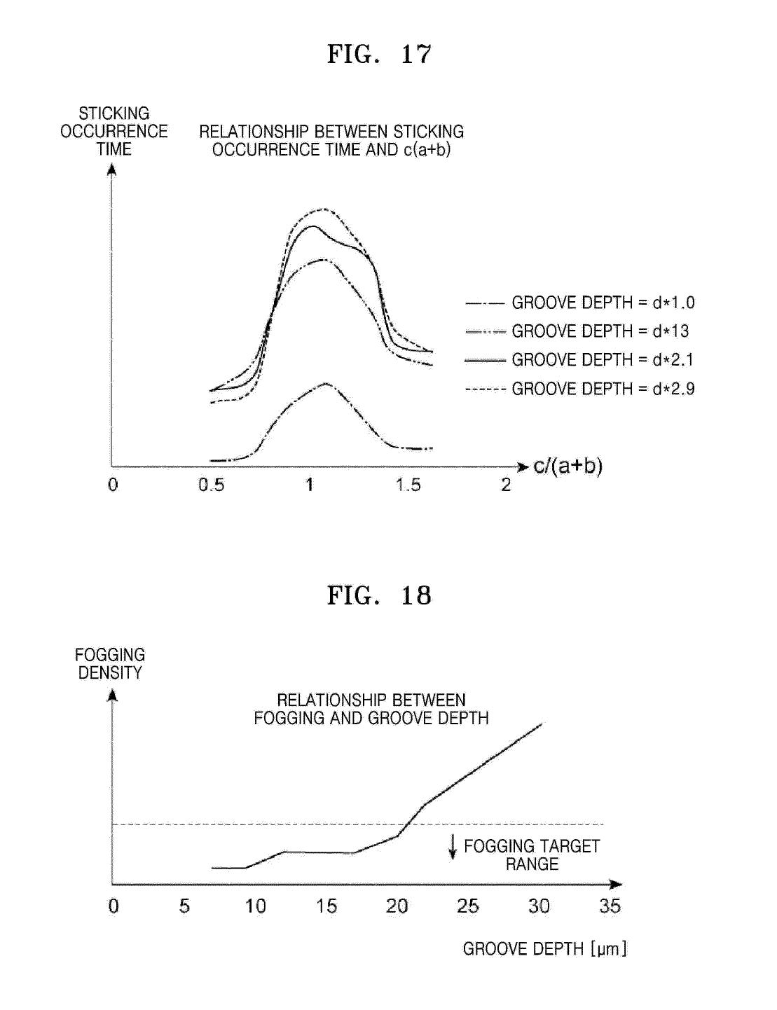

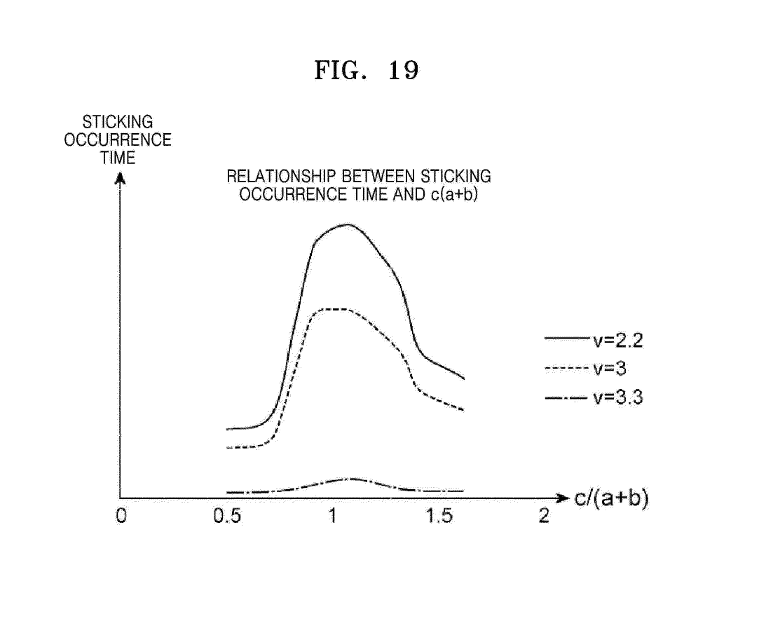

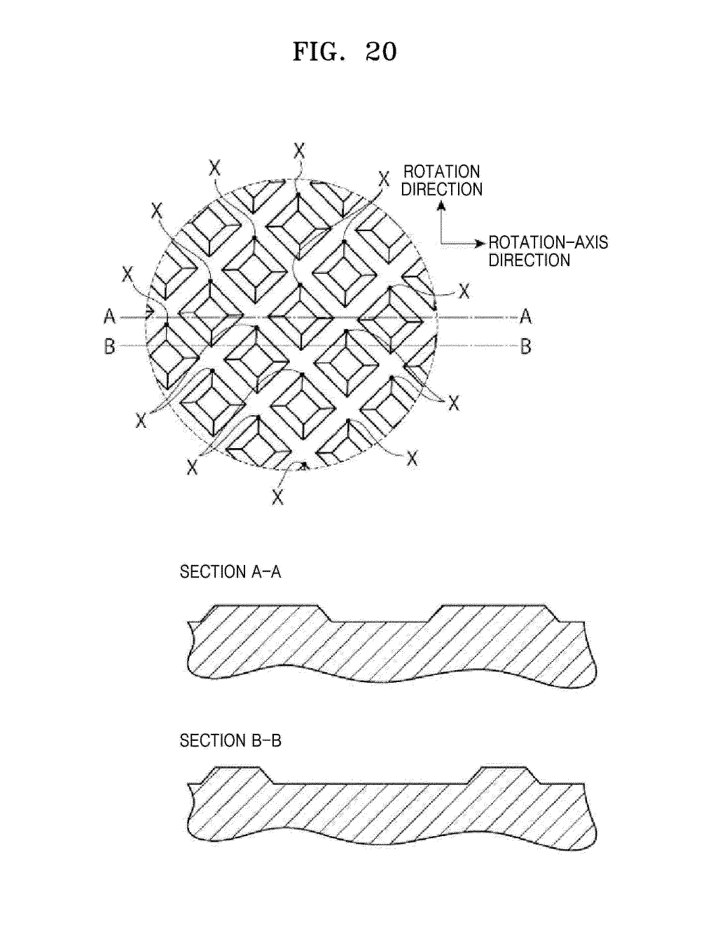

As described above, since c/(a+b) is close to 1, toner may not stagnate on the developing roller 210, and thus as illustrated in FIGS. 17 and 19, toner sticking occurrence time may be delayed, and thus the lifespan of the image forming apparatus may be increased. The first to third concave portions 150 to 152 may satisfy the inequality: d<h<3d where h denotes the depths (groove depth) of the first to third concave portions 150 to 152 and d denotes the average particle diameter of toner. In this case, as illustrated by the graph of FIG. 17, toner sticking occurrence time may be delayed, and thus the lifespan of the image forming apparatus may be increased.

As illustrated in FIG. 18, for example, if the average particle diameter of toner is 7 μm, fogging (surface contamination) caused by toner attached to a non-image region (surface region) of paper may occur less frequently, and fogging density may be reduced to be lower than a target value by adjusting the depths of the first to third concave portions 150 to 152 to be less than 21 μm. As described above, if h<3d, the number of toner particles filled in each concave portions may be fewer than 3. That is, since toner forms a two-particle layer in average, the probability of toner making contact with the developing roller 210 or blade is high. Thus, the toner may be uniformly charged, and fogging (caused by poor charging or reverse charging) may be minimized. The surface shapes of the developing rollers of the embodiments of the invention may be combined for reducing variations of toner density, preventing fogging, and maintaining satisfactory image quality for a long period of time.

As illustrated in FIG. 19, if the ratio (v) of the rotation speed of the developing roller 210 to the rotation speed of the photoconductor drum 30 is maintained to be 3.0 or less, toner sticking occurrence time may be delayed. The ratio (v) may be maintained to be 1.0 or greater in terms of the developing ability of the developing roller 210. That is, the rotation speed of the developing roller 210 may be adjusted to be 1.0 to 3.0 times the rotation speed of the photoconductor drum 30. In this case, sticking of toner may not easily occur, and thus toner filming may be prevented to improve the lifespan of the developing device while maintaining high image density.

The developing device described according to an embodiment may be modified without departing from the spirit and scope of the embodiments of the present invention. For example, the oblique angles of the first and second concave portions 150 and 151 are not limited to 45° as long as the first and second concave portions 150 and 151 make angles with the y-axis direction (rotation direction) of the developing roller 210.

The developing unit 200 may be used in an image forming apparatus and/or in other apparatuses.

The concave and convex shapes of the developing roller 210 may be formed by an etching or rolling method. For example, if a rolling method is used, cylindrical dies having patterns opposite to the concave and convex shapes illustrated in FIG. 15 may be prepared, and the concave and convex shapes illustrated in FIG. 15 may be formed on a cylindrical base material to form a developing roller by rolling the cylindrical dies to press the cylindrical base material. After such an etching or rolling process, the concave and convex shapes may be plated by electroless nickel plating, electroplating, or soft chrome plating. Such plating may smoothly cover fine corner burrs or cuts of the concave and convex shapes and may increase the surface hardness thereof to improve wear resistance.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the present invention as defined by the following claims.

What is claimed is:

1. A developing device comprising:
a developer containing chamber configured to contain the developer;
the developing chamber adjacent to the developer containing chamber;
a barrier wall separating the developer containing chamber and the developing chamber, the barrier wall comprising an opening to connect the developer containing chamber and the developing chamber;
a developer carrier rotatably disposed to carry the developer filled in the developing chamber;
a developer supply member disposed in the developing chamber and configured to supply the developer, supplied through the opening, to the developer carrier; and
a developer regulating member making contact with a circumferential surface of the developer carrier, the developer regulating member being configured to regulate a layer thickness of the developer supplied to a surface of the developer carrier,
wherein the developer supply member is rotatable while facing and making contact with the developer carrier, and the developer supply member and the developer carrier move in opposite directions in a contact region therebetween,
the developer carrier comprises a developer carrying surface comprising a plurality of convex portions configured to contain the developer and concave portions respectively surrounding the convex portions,
a height difference between top surfaces of the convex portions and bottom surfaces of the concave portions is equal to, or greater than, 0.8 times a weight average particle diameter D4 of the developer but less than 5.0 times the weight average particle diameter D4 of the developer,
if an imaginary surface obtained by extending the top surfaces of the convex portions of the developer carrying surface in axial and circumferential directions is defined as an entire circumferential surface, a ratio of a total area of the top surfaces of the convex portions to an area of the entire circumferential surface is equal to, or greater than, 3% but less than 40%,
a contact position between the developer carrier and the developer regulating member is lower than a contact position between the developer carrier and the developer supply member, and
an excessive developer regulated by the developer regulating member from the developer carrier is stored in a developer collecting part disposed at a lower position in the developing chamber.

2. The developing device of claim 1, wherein the developer regulating member comprises an elastic contact part having an end portion extending at least in a width direction parallel to a rotation axis of the developer carrier, and
when the end portion of the elastic contact part faces the concave portions, the end portion of the elastic contact part is spaced apart from the bottom surfaces of the concave portion by a distance greater than the weight average particle diameter D4 of the developer.

3. The developing device of claim 1, wherein a layer thickness of the developer on the top surfaces of the convex portions is regulated to be equal to or smaller than that of a single layer of a developer particle.

4. The developing device of claim 1, wherein a surface hardness ratio of a contact portion of the developer regulating member making contact with the developer carrier to the developer carrier is equal to or greater than 0.20 but less than 1.0.

5. The developing device of claim 1, wherein the developer containing chamber is disposed under the developing chamber, and an agitating member capable of pushing up the developer of the developer containing chamber and supplying the developer to the developing chamber through the opening is disposed in the developer containing chamber.

6. A developing device comprising:
a developing roller comprising a convex portion and a concave portion on a surface thereof for attaching toner to the convex and concave portions; and
a developer regulating member making contact with a surface of the developing roller to regulate an amount of toner attached to the developing roller,
wherein the concave portion of the developing roller comprises:
a first concave portion extending in a direction inclined with respect to a rotation direction of the developing roller,
a second concave portion extending in a direction different from the rotation direction or the direction in which the first concave portion extends, and
a third concave portion continuing from the first and second concave portions and extending in the rotation direction.

7. The developing device of claim 6, wherein the first to third concave portions satisfy the following inequality:
0.7≦c/(a+b)≦1.4
where a denotes a width of the first concave portion in a rotation-axis direction of the developing roller, b denotes a width of the second concave portion in the rotation-axis direction, and c denotes a width of the third concave portion in the rotation-axis direction.

8. The developing device of claim 7, wherein the first to third concave portions satisfy the following inequality:
0.9≦c/(a+b)≦1.2
where a denotes the width of the first concave portion in the rotation-axis direction of the developing roller, b denotes the width of the second concave portion in the rotation-axis direction, and c denotes the width of the third concave portion in the rotation-axis direction.

9. The developing device of claim 8, wherein the sum of the widths of the first and second concave portions measured in a section taken in the rotation-axis direction of the developing roller is equal to the width of the third concave portion measured in the section.

10. The developing device of claim 6, wherein the developing device satisfies the following inequality:
d<h<3d
where h denotes a depth of the concave portion of the developing roller, and d denotes an average particle diameter of the toner.

11. The developing device of claim 6, further comprising a photoconductor drum receiving the toner from the developing roller,
wherein a rotation speed of the developing roller is approximately 1.0 to 3.0 times a rotation speed of the photoconductor drum.

12. The developing device of claim 6, further comprising a toner supply part supplying the toner to the developing roller.

13. A process cartridge comprising:
an electrostatic latent image carrier;
the developing device of claim 1 united with the electrostatic latent image carrier as a single cartridge.

14. A process cartridge comprising:
an electrostatic latent image carrier;
the developing device of claim 6 united with the electrostatic latent image carrier as a single cartridge.

15. An image forming apparatus comprising the developing device of claim 1.

16. An image forming apparatus comprising the developing device of claim 6.

17. A developing roller comprising:
a convex portion and a concave portion on a surface thereof for attaching toner to the convex and concave portions,
wherein the concave portion comprises:
a first concave portion extending in a direction inclined with respect to a rotation direction of the developing roller,
a second concave portion extending in a direction different from the rotation direction or the direction in which the first concave portion extends, and
a third concave portion continuing from the first and second concave portions and extending in the rotation direction.
